(19) United States
(12) Patent Application Publication
(10) Pub. No.: US 2024/0193554 A1
(43) Pub. Date: Jun. 13, 2024

(54) SYSTEMS AND METHODS FOR ACCESS OF COMPLEX INFORMATION AND PROCEDURES FOR OPERATIONS, MAINTENANCE, AND TROUBLESHOOTING OF EQUIPMENT

(71) Applicant: Digital Mentor, Inc., Incline Village, NV (US)

(72) Inventors: Nancy C. Heuman, Cayucos, CA (US); Scott Wenger, Cayucos, CA (US)

(73) Assignee: Digital Mentor, Inc., Incline Village, NV (US)

(21) Appl. No.: 18/444,566

(22) Filed: Feb. 16, 2024

Related U.S. Application Data
(63) Continuation of application No. 17/233,462, filed on Apr. 17, 2021, now abandoned.
Application No. 17/233,462 is a continuation of application No. 17/162,508, filed on Jan. 29, 2021, now abandoned.
Application No. 17/162,508 is a continuation of application No. 17/028,740, filed on Sep. 22, 2020, now abandoned.
Application No. 17/028,740 is a continuation of application No. 16/849,894, filed on Apr. 15, 2020, now abandoned.
Application No. 16/849,894 is a continuation of application No. 16/666,007, filed on Oct. 28, 2019, now abandoned.
Application No. 16/666,007 is a continuation of application No. 16/295,942, filed on Mar. 7, 2019, now abandoned.
Application No. 16/295,942 is a continuation of application No. 16/164,396, filed on Oct. 18, 2018, now abandoned.
(60) Provisional application No. 62/574,585, filed on Oct. 19, 2017.

(51) Int. Cl. G06Q 10/20

(52) U.S. Cl. CPC G06Q 10/20

(57) ABSTRACT

A method of allowing users to maintain equipment forming a facility comprises the following steps. A platform for storing and accessing data is provided. Graphical data representative of the equipment forming the facility is displayed. The platform is populated with user data. The user data is sorted and updated by relevance based on sensor outputs, context, chronology, and spatial relationships to determine whether the equipment forming the facility are operating within parameters associated with the user data.

### RELATED APPLICATIONS

This application, (Attorney's Ref. No. P219971CON) is a continuation of U.S. patent application Ser. No. 17/233,462 filed Apr. 17, 2021, currently pending.

U.S. patent application Ser. No. 17/233,462 is a continuation of U.S. patent application Ser. No. 17/162,508 filed Jan. 29, 2021, abandoned.

U.S. patent application Ser. No. 17/162,508 is a continuation of U.S. patent application Ser. No. 17/028,740 filed Sep. 22, 2020, abandoned.

U.S. patent application Ser. No. 17/028,740 is a continuation of U.S. patent application Ser. No. 16/849,894 filed Apr. 15, 2020, abandoned.

U.S. patent application Ser. No. 16/849,894 is a continuation of U.S. patent application Ser. No. 16/666,007 filed Oct. 28, 2019, abandoned.

U.S. patent application Ser. No. 16/666,007 is a continuation of U.S. patent application Ser. No. 16/295,942 filed Mar. 7, 2019, abandoned.

U.S. patent application Ser. No. 16/295,942 is a continuation of U.S. patent application Ser. No. 16/164,396 filed Oct. 18, 2018, abandoned.

U.S. patent application Ser. No. 16/164,396 claims benefit of U.S. Provisional Application Ser. No. 62/574,585 filed Oct. 19, 2017, now expired.

### TECHNICAL FIELD

This disclosure relates to the field of digital devices configured to provide a technician with information relating to operation and maintenance of equipment at a facility.

### BACKGROUND

Many industries are losing significant numbers of their workforce with retirement of people with decades of experience, and therefore losing institutional, experience-based, tangible and intangible knowledge of the systems these qualified people take with them as they retire. Experience based knowledge often disappears with the retirement or change in long time employees, data is collected but not provided with the ability to know what is normal, or what needs to be done based on the data.

In the current art of operating and maintaining equipment at a facility, the user (technician) spends many years slowly gathering the history, time chronology, training, and performance relative to conditions. These current art information systems include, for example, tangible paper documents, plan drawings, or filing systems, and in many cases information which may be known only to those with a personal knowledge of the equipment and connected systems. In the current art, some documents have been converted to digital format and are accessed by relational driven information systems such as in list structures of data base lists. This information is typically inaccessible due to physical or technical barriers and thus not readily available to the technician in the field. In some examples there may be no communication system available to the technician in the field due to electrical interference, remoteness of the equipment or facility, or other reasons.

In the field of use and maintenance of equipment, some information is intangible, thus experienced based knowledge and is not in written form. This information is compartmentalized in someone's personal knowledge base and builds over time with the feedback from actions taken and resulting outcomes (e.g., learning and memory) or is difficult to share that information with others, or it disappears with the person when they leave the workforce or the facility. For example, a piece of equipment may be a custom production with no user manual, and thus the only place the operation and maintenance information is kept is in the mind of a technician.

Relational driven information systems commonly require a technician to have a high skill level and extensive personal knowledge of the system to access Information or perform a task for operations, maintenance, or troubleshooting. These systems may require an action from the technician to retrieve the information either remotely from the immediate location of the equipment or through an information server (cloud) type system. This information is provided to the technician in discrete units. Often the information is provided with no logical connections between the pathways that integrate all to the discrete units of information to an end of performing a task.

The need exists for improved information storage and distribution systems for operating and maintaining facilities that eliminate or reduce burdens and barriers of conventional information storage and distribution systems.

### SUMMARY

The present invention may be embodied as a method of allowing users to maintain equipment forming a facility comprising the following steps. Providing a platform for storing and accessing data. Displaying graphical data representative of the equipment forming the facility. Populating the platform with user data. Sorting the user data by relevance based on context, chronology, and spatial relationships to determine whether the equipment forming the facility are operating within parameters associated with the user data.

The present invention may also be embodied as a digital information system comprising a mobile computer running a mobile application, a first equipment within a facility, a mobile database residing in non-transient media on the mobile computer, the mobile database comprising data files comprising maintenance information for the first equipment. The first equipment comprises an equipment tag transmitting a proximity signal to the mobile computer. A proximity range is defined around the equipment tag. A proximity detection system receiving the proximity signal from the equipment tag and determining when the mobile computer is within the proximity range of the first equipment. The mobile application configured to display the maintenance information on a graphical interface when the mobile computer is within the proximity range.

### BRIEF DESCRIPTION OF THE DRAWINGS

FIG. 1A-1C contain block diagrams representing a first embodiment of a digital information system of the present invention implemented as a field operation, maintenance, and troubleshooting information system of the present invention as that system evolves over three different points in time;

FIG. 2 is a logic flow diagram illustrating a process of initializing the digital information system of FIGS. 1A-1C;

FIG. 3 is a logic flow diagram illustrating a process of using and updating the digital information system of FIGS. 1A-1C;

FIGS. 4 and 5 are a diagram of one example of the digital information system including facility interconnections;

FIG. 6 is a flow chart of several steps a technician may follow when implementing the disclosed digital information system;

FIG. 7 is a diagram depicting one example of collection points for a data accumulation system;

FIG. 8 is a diagram depicting person-centered decision making;

FIG. 9 is a representation of a component of a data display system;

FIG. 10 is a representation of a component of a data transmission system;

FIG. 11 is a representation of a technician interacting with the data display system;

FIG. 12 is a representation of a data storage system;

FIG. 13 is a flow diagram of one example of the digital information system;

FIG. 13 is a representation of one example of a control system and connections to other components;

FIG. 14 is one example of several interoperating components of an equipment system;

FIG. 15 is a diagram of several data display options within the data display system;

FIG. 16 shows a geographical region with a facility enlarged to show portions thereof;

FIG. 17 shows the facility of FIG. 16;

FIG. 18 shows the facility of FIG. 17 with one of the subsystems enlarged;

FIG. 19 shows a component (clarifier drive);

FIG. 20 shows one of the structures of FIG. 18 enlarged;

FIG. 21 shows one example of an equipment component of the subsystem shown in FIG. 20;

FIG. 22 is a diagram of information flow between a mobile computer and other data structures;

FIG. 23 is an environmental representation of a technician utilizing the information presentation system in the field;

FIG. 24 is a diagram of one example of one example of the data storage system;

FIG. 25 is a diagram of one example of the data storage system including associated components and systems;

FIG. 26 schematically illustrates an example of initial input associated with first, second, and third systems associated with a facility;

FIG. 27 schematically illustrates an example of initial association(s) and effect on criteria for predictive associations related to the first, second, and third systems depicted in FIG. 26;

FIG. 28 schematically illustrates an example of logical association(s) associated with the first, second, and third systems depicted in FIG. 26;

FIG. 29 schematically illustrates occurrences for various inputs/outputs over time; and

FIG. 30 schematically illustrates associations between events and associated actions and the associated provision of information associated with the associated actions.

### DETAILED DESCRIPTION

### I. Digital Information System

The digital information system disclosed here in one example includes a mobile computer information platform that can be modified automatically through processing of external inputs that include but are not limited to electronic sensors, RFID tags, data from relevant programs, geographically relevant information such as weather and location, and user input. The disclosed digital information system of one example simulates how the human brain learns. This digital information system of one example organizes information for storage and retrieval in a contextual database by using complicated interrelationships of system information. The result is that a body of information can be created that provides a transition of knowledge from an experienced technician or technicians to a less experienced technician or technicians. This tool can be used by technicians, engineers, operators, mechanics, managers, and any person who is a part of a group that comprises a system of interrelated components or equipment. This digital information system can be applicable for government agencies, utilities, manufacturing plants, emergency response operations, by the military and any organization engaged in executing a complex task.

A person learns a complicated system or process to become an expert as the human brain starts putting together an understanding of a new experience by initially creating isolated nodes of information such as observations, smell, sound, color, shape, location, time, date, or movements. These isolated nodes slowly link together and new nodes are added as the human brain is fed with information, data, cause and effect experience, observations, feedback from actions taken, and an understanding of the artistry of mastering a complicated process or system begins. The connections between information are modeled by an irregular network of associations of knowledge that resembles a graph database structure.

The disclosed digital information system of one example is analogous to a graph database.

In computing, a graph database uses graph structures for queries with nodes, edges, and properties to represent and store data. A main concept of the system is the graph (edge or relationship). The graph relates the data items in the store to a collection of nodes and edges, the edges represent the connections between the nodes. The connections allow data in the store to be linked together directly and, in many cases, retrieved with one operation. Graph databases hold the connections between data as a priority. Querying connections is fast, as connections are perpetually stored and updated in the database. Connections can be intuitively visualized using graph databases, making them useful for heavily inter-connected data.

Graph databases are a type of NoSQL database, which address several limitations of relational databases. While the graph model explicitly lays out the dependencies between nodes of data, the connections model and other NoSQL database models link the data by implicit connections. Connections in a graph database and be labelled, directed, and given properties. This is compared to relational approaches where these relationships are implied and must be reverified at run-time.

The underlying storage mechanism of graph databases can vary. Some depend on a relational engine and “store” the graph data in a table (although a table is a logical element, therefore this approach imposes another level of abstraction between the graph database, the graph database management system and the physical devices where the data is actually stored). Others use a key-value store or document-oriented database for storage, making them inherently NoSQL structures. Retrieving data from a graph database often utilizes a query language other than SQL, which was designed for the manipulation of data in a relational system and therefore cannot “elegantly” handle traversing a graph.

The digital information system can function as a matrix for storing and accessing information with changeable connections, links, or associations between information units (nodes). In one example, information (documentation) relating to an industrial facility is collected from various sources such as: plant offices, manufacturers, engineers, remote sales staff, technical service staff, subject matter experts (SME), etc. This information is broken into discrete parts or units of information (nodes in a graph database) and is interlinked by connections (associations in a graph database).

This information organizational structure of one example allows for unrestrained queries, as any node may be associated with any other node. This is different than the prior art where information is ordered in relational databases. In such relational databases, a user has to have advance knowledge of the system in order to understand how to access information relevant to other equipment in the system. Prior relational databases use and updating often requires a specialist familiar with the equipment in the system and facility. These relationship databases are created with specific queries anticipated in order to create an organizational structure. This type of relational database is useful for data queries within pre-decided responses, similar to providing answers in a fillable form with pull-down options. A person can query the results with the constraint that the query was anticipated by the creator of the database structure.

Information use in an industrial or complex system environment is not always used with constraints on the inquiry. The environment is dynamic, with many nodes of information about the system and the combinations of events may be near infinite. The disclosed digital information system accelerates the learning process for logical responses and predictions for future events based on human sensory inputs, mechanical and electrical sensors, human memory of experiences with associations between information defined and updated by individual users of the system.

Disclosed herein are several examples of digital information systems implementing the principles of the present invention, and each of these examples will be discussed separately below.

### II. First Example Digital Information System

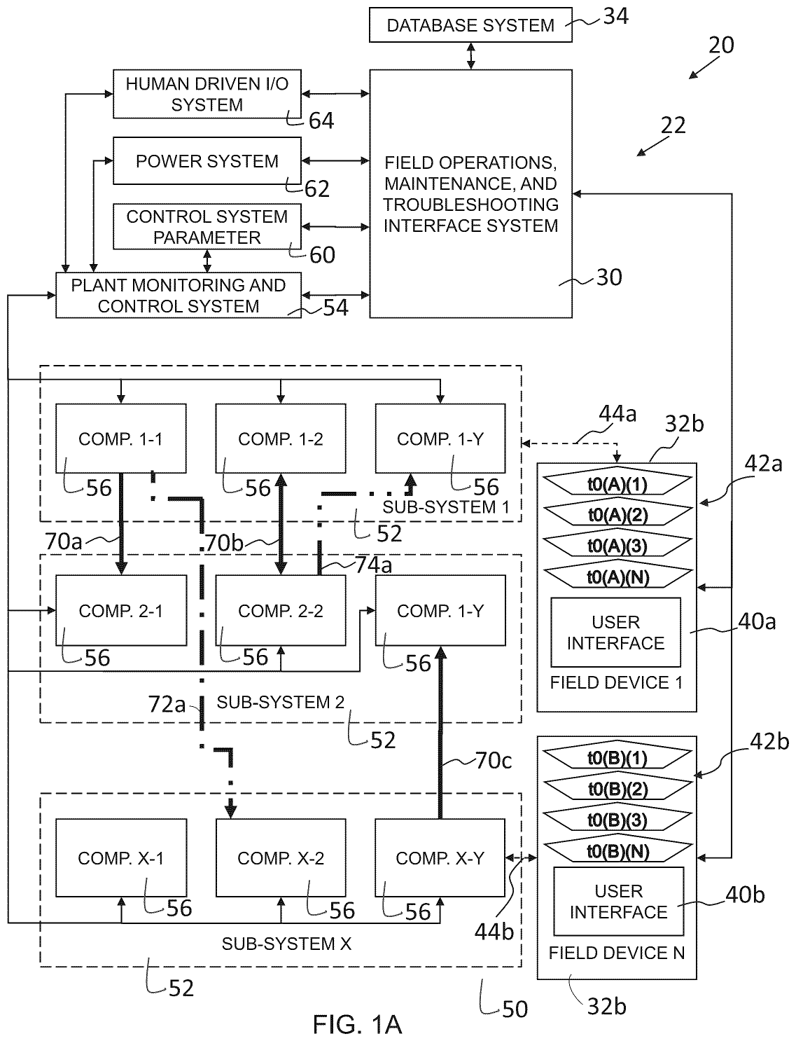

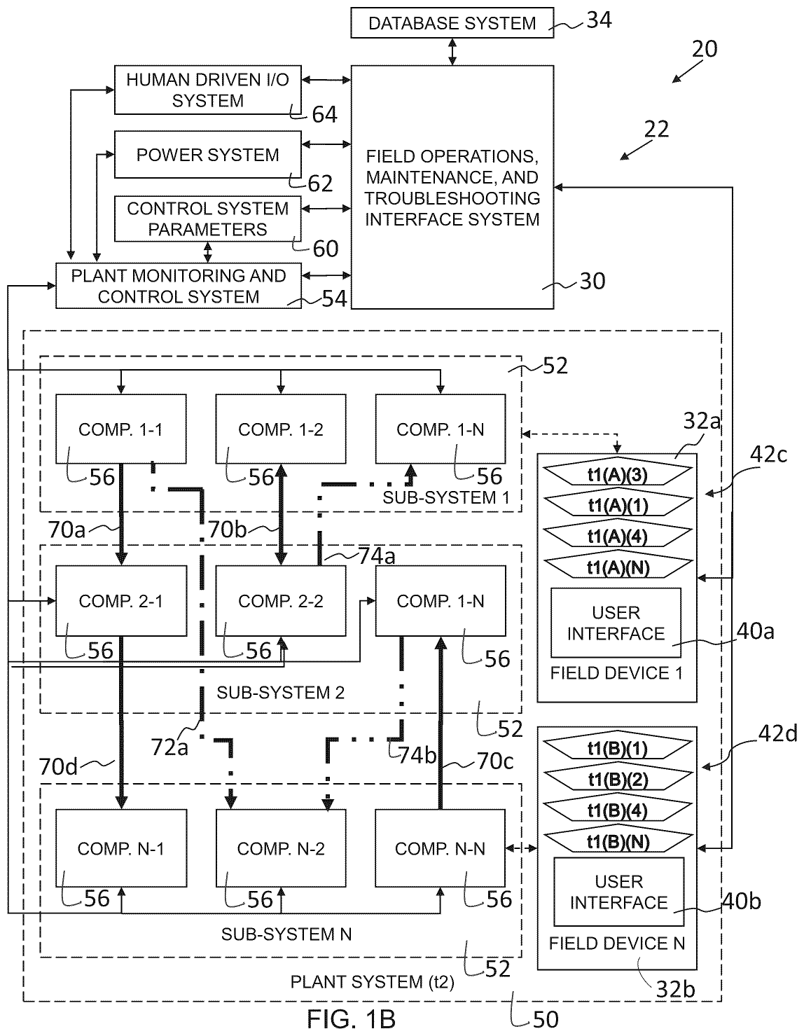

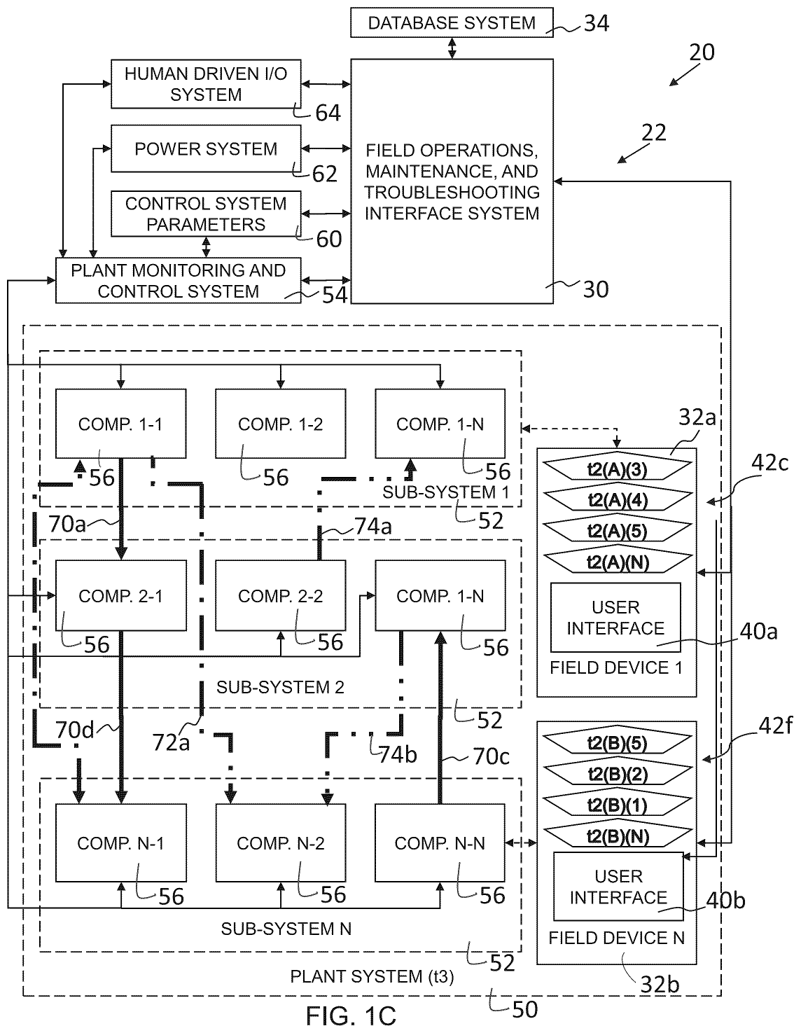

Referring initially to FIGS. 1A-1C of the drawing, that drawing schematically represents a facility 20 and a first example digital information system 22.

The example digital information system 22 comprises a field operation, maintenance, and troubleshooting interface system 30 (may be referred to as the interface system 30), at least one field device 32, and a database system 34. In the following discussion, letters appended to numerical reference characters refer to specific instances of a generic component associated with the numerical reference character. A specific component identified in the drawing by the combination of a numerical reference character and a letter appended thereto is thus not considered to be different from the generic component referred by the numerical reference character in text.

The interface system 30 is a software system running on one or more physical computers capable of interfacing with the at least one field device 32 and the database 34 and implementing the functionality of the example digital information system 22 as described herein.

The example field device(s) 32 comprises a user interface 40, memory for storing a task list 42 comprising at least one task, and a field parameter system 44 for establishing field parameters associated with the field device(s) 32. The example field device(s) 32 are or may be portable computing devices such as tablet computers, smart phones, laptop computers, and the like. The example field device(s) 32 are further wired or wireless connected to the interface system 30 to allow data to be transferred between the interface system 30 and the field device(s) 32. The user interface 40 is capable of communicating data to the user and allowing the user to input data into the field device(s) 32. Examples of user interface devices that may be used to form the example user interface 40 include touchscreen displays, keyboards, touchpads, computer mice, speakers, microphones, cameras, motion capture gloves, and the like, alone or in any appropriate combination.

The field parameters system 44 generated by the digital information system 22 may be, as examples, one or more of a GPS system for determining absolute position of the field device(s) 32, an RFID system for determining position of the field device(s) 32 relative to one or more components associated with the facility 20, and/or a user input system for allowing the user to identify absolute location of the field device(s) 32 and/or position of the field device(s) 32 relative to one or more components associated with the facility 20. The field parameters may thus be associated with at least one of absolute location, location with respect to one or more components of the facility 20, and/or another other information that allows the field device(s) 32 to display task list(s) 42 on the user interface 40 to allow the interface system 32 to propose or direct the performance of appropriate field operation, maintenance, and/or troubleshooting tasks.

The example facility 20 comprises a plant system 50 comprising at least one plant sub-system 52 and a plant monitoring and control system 54. Each plant sub-system 52 comprises at least one system component 56. At least one of the system components 56 is connected to at least one other of the system components 56 to form the sub-systems 52, and at least one of the plant sub-systems 52 is connected to at least one other of the plant sub-systems 52 to form the plant 50.

The schematic example plant 50 comprises two or more sub-systems 52, and each sub-system 52 comprises at least one component 56. In the example plant 50, the sub-systems 52 are represented by sub-system identifiers comprising integers of 1 to X and each component 56 is represented by a primary integer corresponding to one of the sub-system identifiers and a secondary identifier comprising an integer of 1 to Y. Typically, X is 2 or greater and Y is 1 or greater for any example plant 50. Other naming conventions capable of identifying sub-systems 52 and components 56 may be used.

The plant monitoring and control system 54 is configured to interface with and control the plant system 50 such that the plant system 50 implements desired functionality. In FIGS. 1A-1C, thin solid lines indicate communications paths, thin broken lines indicated relationships between the at least one field device and at least one sub-system 52 and/or at least one system component 56. Thick solid and broken lines indicate certain predetermined and/or ascertained operational, maintenance, and/or troubleshooting relationships between the components 56, but not all operational relationships among sub-system(s) 52 and/or system component(s) 56, such as mechanical connections, fluid flow, and/or power flow, are depicted in FIGS. 1A-1C.

FIGS. 1A-1C further indicate that the facility 20 further comprises a control system parameter module 60, a power system 62, and a human driven I/O system 64. The control system parameter module 60 contains production parameters that the plant monitoring control system 54 uses to control operation of the plant system 50, and data indicative of the status of the control system parameter module 60 is accessible by the interface system 30. The production parameters may determine operational characteristics of the plant system 50 such as material throughput and the like. The power system 62 provides power to the plant system 50, and data indicative of the status of the power system 62 is accessible by the interface system 30. The power system 62 is typically connected to an external utility power system (not shown) and may not be controlled by the plant system 50. In this case, the data indicative of the status of the power system 62 may vary during normal operation of the utility power system, and the monitoring and control system 54 and interface system 30 may measure or detect parameters of the power system 62 indicative of such variations. The human driven I/O system 64 allows users to input data relevant to operation of the plant monitoring and control system 54. Data stored in the human drive I/O system 64 is accessible by the interface system 30. As one example, the data input to the human drive I/O system 64 may be lab results associated with fluid flowing through one of the components 56 of the plant system 50.

The task list(s) 42 contain task(s) that a technician may perform while operating, maintaining, and/or troubleshooting the plant system 50. These task list(s) 42 are displayed by the user interface(s) 40 of the field devices 32 as appropriate for performance of the task(s). The task(s) are typically defined and ordered based on experience with operating, maintaining, and troubleshooting the plant system 50. The tasks may be defined based on direct technician experience. For example, a technician may determine that a particular component 56 is best maintained by disassembly and reassembly in a particular order. Further, tasks may be defined based on relationships among two or more sub-systems 52, two or more components 56, and/or among one or more sub-systems 52 and one or more components 56. For example, it may be determined that when a pressure level of one component 56 in one sub-system 52 exceeds a certain level, a second component 56 of another sub-system 52 must be replaced. Additionally, tasks may be determined based on a combination of technician experience and relationships among sub-systems 52 and components 56.

FIGS. 1A, 1B, and 1C schematically depict a status of the example digital information system 22 at three points in time. Experience with the plant system 50 over time may redefine the parameters of the interface system 30 and thus result in new tasks and new task lists 42.

At a first point in time t0 as depicted in FIG. 1A, the example digital information system 22 is configured based on a first, second, and third primary relationships 70a, 70b, and 70c represented by thick solid lines, a first secondary relationship 72a represented by a thick single dot broken line, and a first tertiary relationship 74a represented by a thick double dot broken line. In the example of FIG. 1A, the primary relationships 70a, 70b, and 70c, the secondary relationship 72a, and the tertiary relationship 74a are determined for the plant system 50 based on operation of the plant system 50 as understood upon initialization.

Based on these relationships 70a, 70b, 70c, 72a, and 74a, first and second sets of tasks t0(A) and t0(B) are created for field parameters A and B associated with the sub-system 1 and the component X-Y of the plant system 50, respectively. In particular, the first task list 42a contains tasks t0(A)(1), t0(A)(2), t0(A)(3), and t0(A)(N), with the tasks being ordered from top to bottom as depicted in FIG. 1A. The second task list 42b contains tasks t0(B)(1), t0(B)(2), t0(B)(3), and t0(B)(N), with the tasks being ordered from top to bottom as depicted in FIG. 1A. In the example system digital information system 22, the tasks are identified by point in time (e.g., “t1” or “t2”), field parameter (e.g. “A” or “B”), and an integer from 1 to N, with N being equal to or greater than 1.

At a second point in time t2 as depicted in FIG. 1B, the example digital information system 22 is configured based on the first, second, and third primary relationships 70a, 70b, and 70c as well as a fourth primary relationship 70d, the first secondary relationship 72a, and the first tertiary relationship 74a and a second tertiary relationship 74b. In the example of FIG. 1B, the primary relationships 70a, 70b, 70c, and 70d, the secondary relationship 72a, and the tertiary relationship 74a and 74b are determined for the plant system 50 based on operation of the plant system 50 as understood based on knowledge gained during the operation of the plant system 50 in a time period T1 between the first and second points in time t0 and t1. In particular, the fourth primary relationship 70d and the second tertiary relationship 74b were unknown upon initialization of the plant system 50. The understanding gained by operating the plant system 50 during the time period T1 results in third and fourth sets of tasks 42c and 42d created for field parameters A and B associated with the sub-system 1 and the component N-N of the plant system 50.

Based on these relationships 70a, 70b, 70c, 70d, 72a, 74a, and 70d third and fourth sets of tasks 42c and 42d are created for field parameters A and B associated with the sub-system 1 and the component N-N of the plant system 50, respectively. In particular, the third set of tasks t1(A) contains tasks t1(A)(3), t1(A)(1), t1(A)(4), and t1(A)(N), with the tasks being ordered from top to bottom as depicted in FIG. 1B. The fourth set of tasks t1(B) contains tasks t1(B)(1), t1(B)(2), t1(B)(4), and t1(B)(N), with the tasks being ordered from top to bottom as depicted in FIG. 1B. It can be seen that the third and fourth sets of tasks t1(A) and t1(B) differ both in composition and in order relative to the corresponding first and second sets of tasks 42a and 42b at time t0.

At a third point in time t3 as depicted in FIG. 1C, the example digital information system 22 is configured based on the first, third, and fourth primary relationships 70a, 70c, and 70d, the first secondary relationship 72a, and the first and second tertiary relationships 74a and 74b. In the example of FIG. 1C, the primary relationships 70a, 70c, and 70d, the secondary relationship 72a, and the tertiary relationship 74a and 74b are determined for the plant system 50 based on operation of the plant system 50 as understood based on knowledge gained during the operation of the plant system 50 in a time period Tc between the second and third points in time t1 and t2. At the third point in time t2, it has been determined that the second primary relationship 74b is not relevant. The understanding gained by operating the plant system 50 during the time period t2 results in fifth and sixth sets of tasks 42e and 42f created for field parameters A and B associated with the sub-system 1 and the component N-N of the plant system 50. The fifth set of tasks 42e contains tasks t1(A)(3), t1(A)(4), t1(A)(5), and t1(A)(N), with the tasks being ordered from top to bottom as depicted in FIG. 1C. The sixth set of tasks 42f contains tasks t2(B)(5), t2(B)(2), t2(B)(1), and t2(B)(N), with the tasks being ordered from top to bottom as depicted in FIG. 1C. It can be seen that the fifth and sixth sets of tasks 42e and 42f differ both in composition and in order relative to the corresponding third and fourth sets of tasks 42c and 42d at time t1.

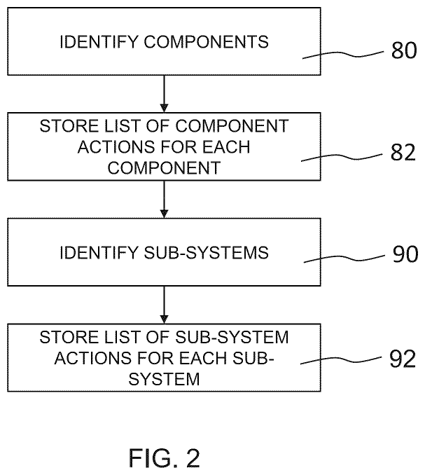

FIG. 2 of the drawing contains a logic flow diagram of the process of initializing the example interface system 30 prior to the time t0. In this initialization process, components are identified at step 80, and an action list is stored, as appropriate, for each identified component at step 82. At step 90, sub-systems are identified, and a list of sub-system actions are stored for each sub-system at step 92. The actions stored at steps 82 and 84 are used to define the task lists 42 as described above. The component actions and sub-system actions are determined at least in part based on relationships among the various components and sub-systems.

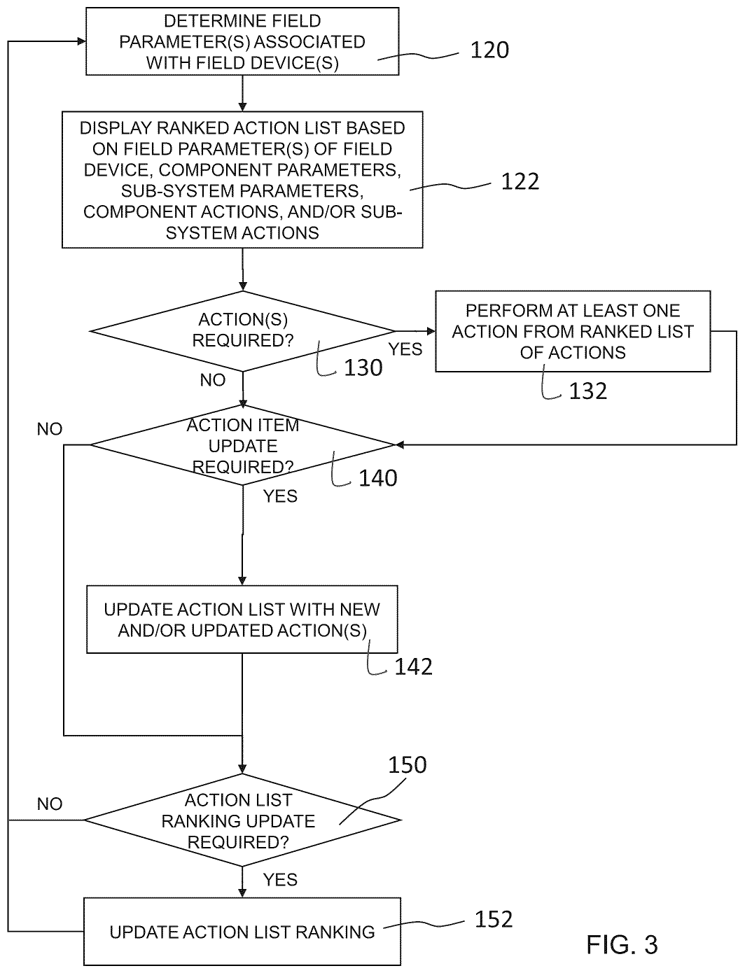

FIG. 3 of the drawing contains a logic flow diagram of the process of using the example digital information system 22 after the time t0. While using the example digital information system 22, a field parameter is determined for each of the field devices 32 as illustrated at step 120. Based on the field parameter determined for a particular field device 32, a ranked action list 42 is communicated to the user using the user interface 40 at step 122. As discussed above, the appropriate ranked action list 42 is determined based on field parameters, component parameters, sub-system parameters, component actions, and/or sub-component actions.

At step 130, the technician determines whether the task lists 42 communicated to the technician requires appropriate action(s) or task(s). If action(s) or task(s) are required, the appropriate action(s) or task(s) are performed at step 132. If no action(s) or task(s) are required, the process proceeds to step 140.

At step 140, the technician determines whether new action(s) or task(s) are required or existing action(s) or task(s) need to be updated. If new or updated action(s) or task(s) are required, the process moves to step 142 at which the technician updates the action or task list. After the action or task list is updated, or if no new or updated action or task is required, the process moves to step 150.

At step 150, the technician determines whether the list ranking needs to be updated. If so, the technician updates or re-orders the action or task list at step 152. The process then returns to step 120 and repeats so long as the field device is still in use. An optional verification step may be performed after one or both of the updating steps 142 and 152 to allow third party (e.g., management) verification of any updating of the digital information system 22 performed by the technician.

The combination of the database 34 and the interface system organizes information for storage and retrieval by learning complicated interrelationships of system information. The result is that the digital information system 22 establishes and is capable of continual modification of a body of information that provides a transition of knowledge from an experienced person to less experienced people. The example digital information system 22 may be used by engineers, operators, mechanics, managers, and any person who is a part of a group that is responsible for designing, operating, maintaining, and troubleshooting the plant system 20 with which a particular instance of the example digital information system 22 is associated. The plant system often takes the form of an industrial processing plant but may be more broadly applied to other types of plant systems such as government agencies, utilities, manufacturing plants, emergency response operations, the military systems, and any organization engaged in executing a complex task.

The example digital information system 22 of the present invention functions as a matrix for storing and accessing information with changeable links or associations between information units (nodes). For example, information (documentation) relating to an industrial facility is collected from various sources such as plant offices, manufacturers, engineers, remote sales staff, technical service staff, subject matter experts (SME), etc. This information is broken into discrete parts or units of information (nodes in a graph database) and is interlinked by connections (associations in a graph database).

The example database 34 of the example digital information system 22 may take the form of or be similar to a Graph database. Unlike a system in which information is ordered in relational databases, the information organizational structure implemented by the example digital information system 22 allows for unrestrained queries, as any node may be associated with any other node. These are created with specific queries anticipated in order to create an organizational structure. The type of database used by the example digital information system 22 is useful for data queries within pre-decided responses. A person can query the results with the constraint that the query was anticipated by the creator of the database structure. The example digital information system 22 thus can easily accommodate complex industrial or other system environments without constraints on the inquiry. The environment is dynamic with many nodes of information about the system and the combinations of events are near infinite. The continual use and updating process implemented by the systems and logic of the example digital information system 22 thus accelerates the learning process for producing logical responses and predictions related to the plant system 50 for future events based on bodies of knowledge related to operations, maintenance, and troubleshooting.

In addition, the example digital information system 22 provides a learning feedback loop that processes external inputs to adapt the content of the database 34 for increased detail of content and intuitive information access. The example digital information system 22 recognizes relevant data and actions and can provide suggestions for actions based on previous actions in similar situations. The feedback loop is the creation of associations between existing nodes and/or the creation of new nodes based on environmental or operator inputs within the graph database. Tools such as Artificial Intelligence (AI) and pattern recognition may be used to synthesize associations. Suggested queries to the database may also be synthesized with processing tools using environmental inputs.

As a method, the principles of the present invention may be embodied using, for example, the digital information system 22 described above, as follows:
Step 1: Collect available information about the facility, operation or system. This may include procedures, technical manuals, operation and maintenance information, plans, safety data sheets (MSDS), flow diagrams, construction documents, reports, permits, etc.
Step 2: Assemble the collected information into the structure (e.g., database format and logic) implemented by the example digital information system 22. Again, this structure may be analogous to a Graph database. Information may be subdivided into small units of information (e.g., nodes) during this Step 2.
Step 3: Associations or relationships between nodes are determined based on the source of the information. For example, Subject Matter Experts (SME) may be used to pre-associate information that isn't readily apparent when the system is defined.
Step 4: Graphically based human-machine interface (HMI) screens are prepared for a mobile computing device (phone or tablet) used in the field by users such as plant technicians.
Step 5: One or more inputs mechanism for are provided to allow users to input information from local sources and observations and organize such information by association or relationship among components. Associations or relationships may be input by gestures on the HMI or by other input methods on the mobile device.
Step 6: The database nodes and associations are updated during use of the digital information system 22 through standard connection protocols. The updating process may include input from:
Sensors (i.e. standalone Internet of Things, Bluetooth, or within overall control system);
RFID tags;
Inputs/Outputs from Programmable Logic Controller (PLC) (i.e. access by address in Wonderware or FactoryTalk);
Lab data (i.e. output from Hach Wims);
Maintenance Management System data (i.e. output from Maximo);
Weather data (i.e. collect from widget);
Captured information from communication (data extraction from text and emails);
Data Historian info for inputs to SCADA server;
Location from GPS on user mobile device;
Sensors on the mobile device apps (i.e., Sound spectrum analysis on Signal Scope, Vibration on SCraMP); and
Photo, video, and sound inputs from user.

The update data collected using the example digital information system 22 as described in this Step 6 may be used to, (a) generate predictive queries; (b) create relationships; (c) create new nodes of information (A+B+C was significant); and (d) prompt the user to create nodes. The node associations may be created by conditional logic operators, and one example of a conditional logic operator may be a Boolean algebraic statement.
Step 7: Process inputs to provide outputs of the example digital information system 22 based on existing or newly established nodes and associations or relationships.
Step 8: Process inputs to provide suggestions for inquiries into the digital information 22 about the plant system 50 based on inputs, patterns of inputs, and temporal relationship(s). Factors such as rates of change of parameters may be considered. Predictive outcomes are presented based on inputs.
Step 9: Process inputs to modify associations between data based on outcomes.

Step 10: A Bayesian processor may be provided to enhance the ability to create predictive suggestions based on probability of past occurrences. As an example, next steps may be predicted based on assessment of answers to questions such as “what conditions were present prior to this observable event?”, using techniques such as Baye's theorem and past inputs as a means to developing rational response to a current condition. As another example, predictive suggestions may be based on a Bayes Theorem differentiator calculating the probability of future events.

### III. Second Example Digital Information System

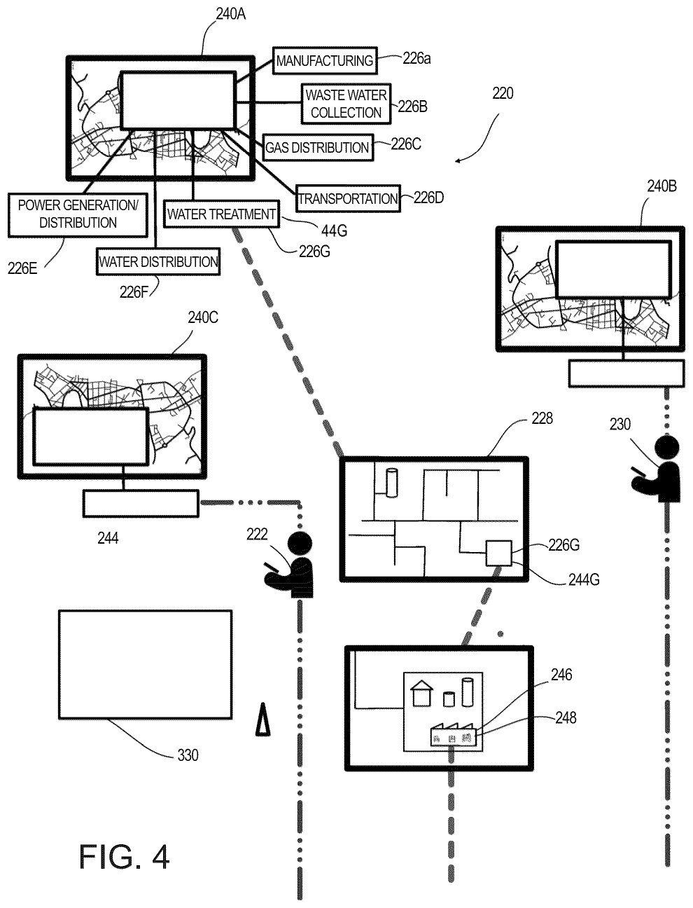

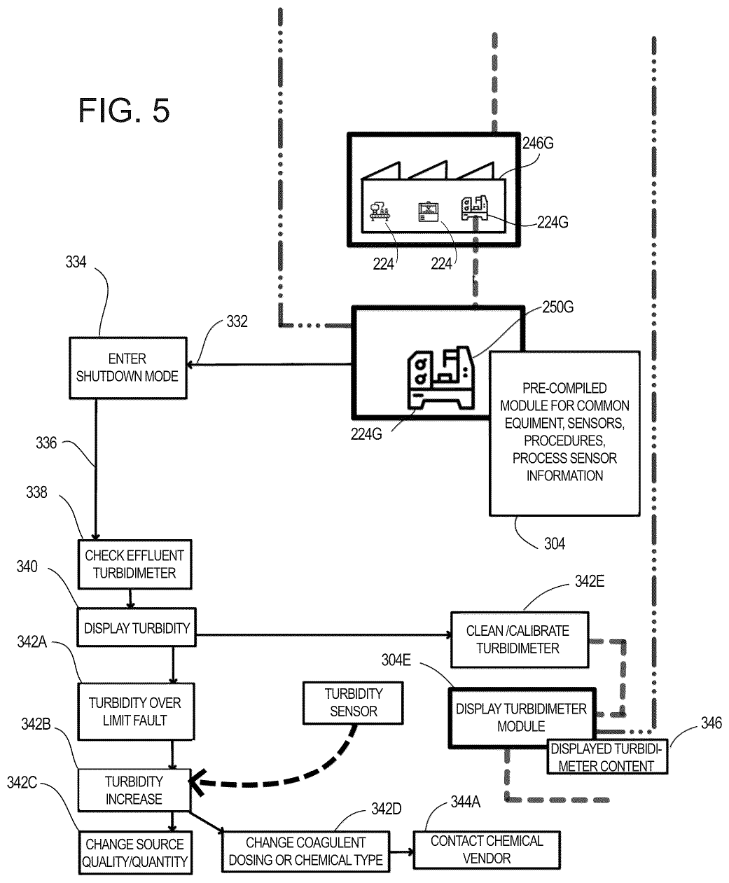

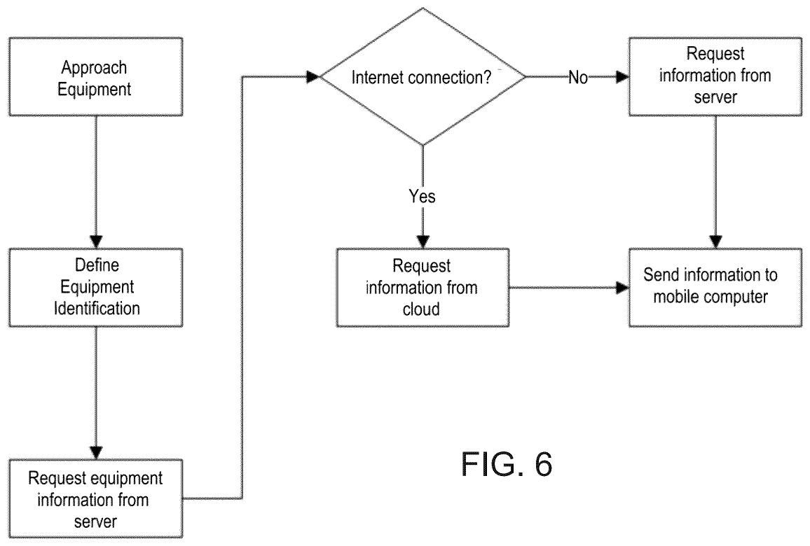

Turning now to FIGS. 4 and 5 of the drawing, depicted therein is a second example a digital information system 220 for operation, maintenance, and troubleshooting of equipment at a facility or across facilities. The term equipment used herein to encompass machinery, vehicles, structures, sensors, data storage devices, and other assets. In the current state of the art, equivalent information is stored and accessed by context driven information systems. The term “context” and variations thereof in this disclosure defined as the circumstances that form the setting for an event, statement, or idea, and in terms of which it can be fully understood and assessed.

The disclosed digital information system 220 is a system that collects and provides data, history, documents, observations, cause and effects in the context and pattern of learning, providing the human brain with an easy tool to build the network of association and interconnection of knowledge quickly.

In addition, the digital information system 220 provides a learning, feedback loop that processes external inputs to adapt the digital information system content for increased detail of content and intuitive information access. In one example, the digital information system recognizes relevant data, actions, and can provide suggestions to the technician for actions (e.g., maintenance tasks) based on previous actions in similar situations.

The feedback loop of one example is the creation of associations between existing nodes and/or the creation of new nodes based on environmental or operator inputs within the graph database. Tools such as artificial intelligence (AI) and pattern recognition may be used to synthesize associations. Suggested queries to the database may also be synthesized with processing tools using environmental inputs.

In one example, the disclosed digital information system 220 functions analogously to a graph database of information that can consist of a collection of smaller graph databases (modules) with nodes and associations for parts of the process. These modules can be assembled as building blocks for processes, to use similar portions of systems with other systems. The technicians then create additional associations by their knowledge as a subject matter expert (SME) and by their actions.

The disclosed digital information system 220 provides a system for facilitating learning of equipment maintenance more rapidly than traditional methods and passing on complicated knowledge and experience from experienced technicians to other technicians.

The digital information system 220 finding particular application for: asset management, maintenance management, engineers, managers O&M troubleshooting for any industrial system, industrial processes, manufacturing, first responders—rapid processing of observations into prioritized actions, emergency operations—emergency power, medical, military operations/logistics/training. Disclosed herein is a digital information system 220 in several examples comprising several systems interoperating to provide a technician 222 with data and instructions for the maintenance, operation, status checking, and troubleshooting of equipment 224 within a facility 226. The example facility 226 is a wastewater treatment system that implements mechanical, chemical, and/or biological processes in series with feedback loops used where necessary to control the process(es) to obtain a desired output criterion. A mobile database of the digital information system 220 resides on a mobile computer 228, thus allowing the technician to easily access the files 230 for localized equipment while in the facility 226 where a data communication system may not be accessible to the mobile computer 228. This may be facilitated by storing the mobile database on non-transient media on the mobile computer 228, thus allowing access to the mobile database in regions of the facility 226 where no communication connection is present.

The mobile computer 228 may be a laptop computer, tablet, smartphone, etc. with an output system 232 which may include outputs such as a graphical interface 234, audio output 236 (e.g. speaker), and tactile feedback 238 (e.g. vibration). The output system 232 indicates to the technician 222 that attention and/or action are required. In one example this output system 232 indicates to the technician 222 that they are in the proximity of equipment 224 that needs maintenance.

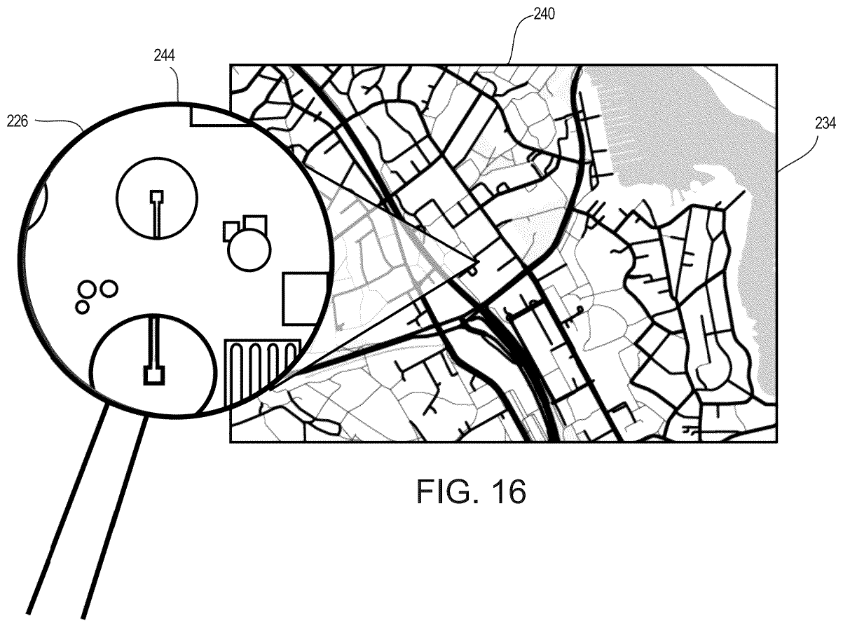

In one example, shown in FIGS. 4 and 16, when maintenance is needed on equipment, the output system 232 may show on the graphical interface 234 a visual representation of a geographical region 240 such as a city, town, county, subdivision etc. In one example, the relative location of the facility 226 is shown by a callout or other method. The technician 222 may be informed via graphical interface 234, audio output 236, tactile feedback 238, or other methods how to approach the facility 226 from any location, including their present location. This may include the use of a GPS receiver in the mobile computer 228.

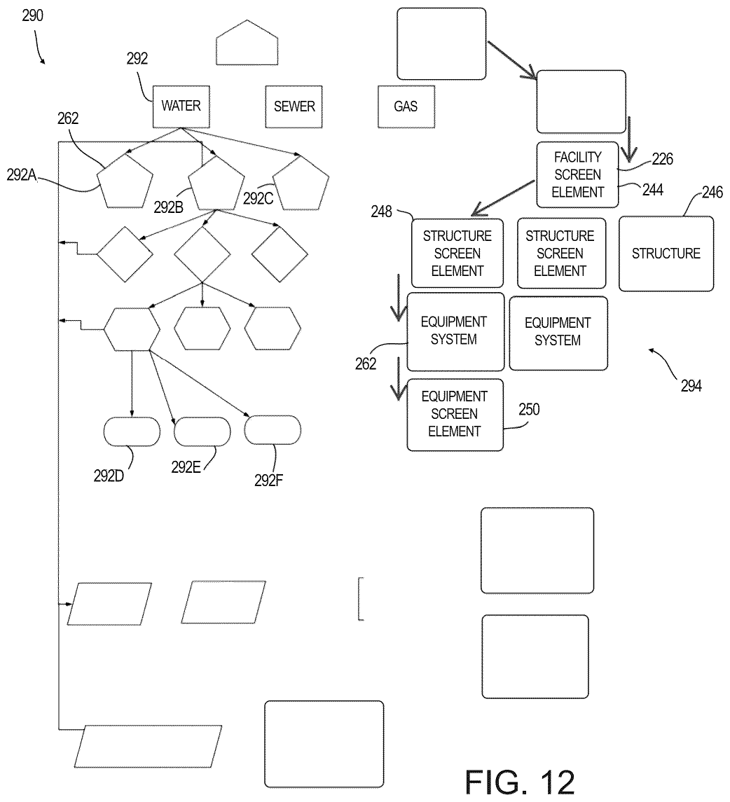

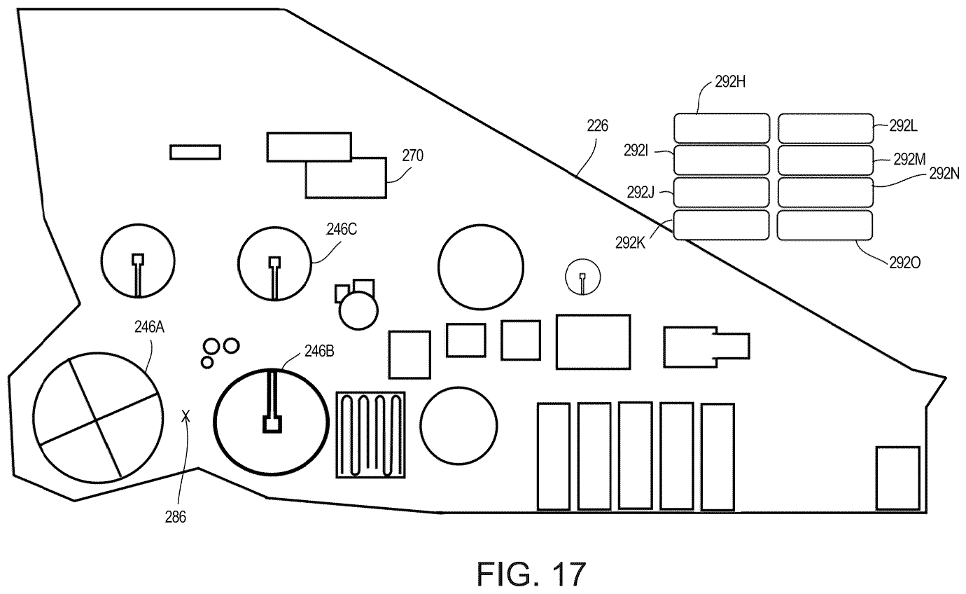

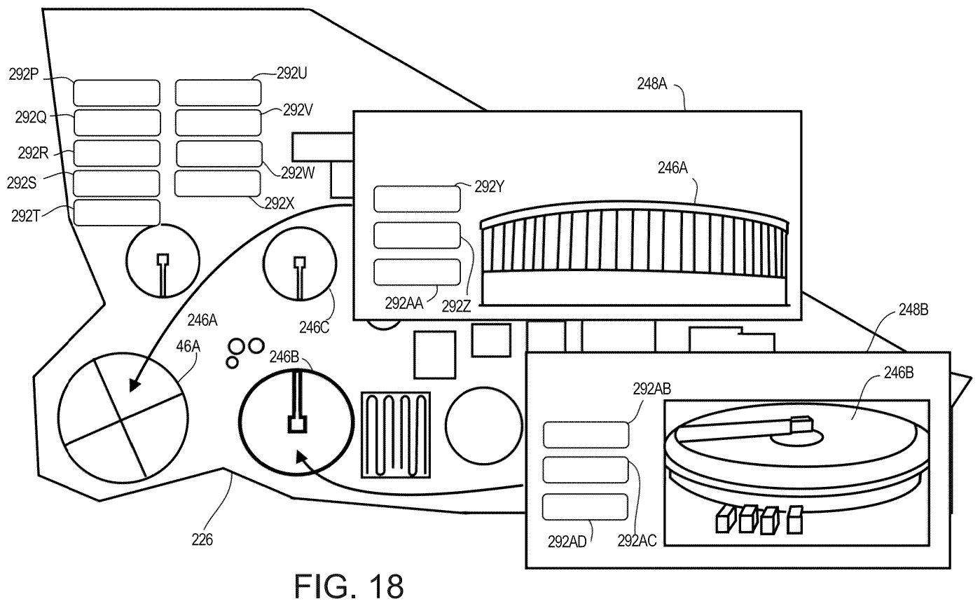

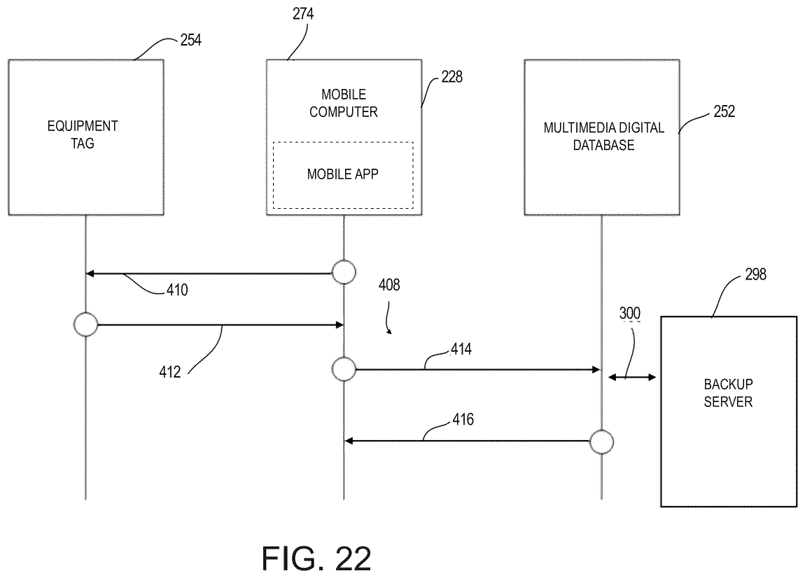

In one example, when a proximity detection system 242 (see, e.g., FIG. 22) determines that the technician 222 is near or within the facility 226, or in another example where the technician selects a facility radio button 244, the display may change to a larger view of the facility 226 indicating one or more structures 246 (e,g., structures 246A-246C in FIGS. 17 and 18) within the facility 226. Such a radio button or option button is a graphical control element that allows the technician 222 to choose one of a predefined set of mutually exclusive options. For example, radio buttons: 292H for standard operating procedures (SOP), 292I for plant operations and maintenance, 292K for operations and maintenance (O&M) library, 292L for operations and maintenance videos, 292M for drawings, 292N for a process flow diagram (FIG. 12), and 292O for a daily rounds fillable form 284. Selection of a particular radio button 292 pulls up on the graphical interface 234 a new display indicative of the radio button chosen for the displayed facility 226. Radio buttons may have a special designed user interface to provide intuitive knowledge of where for the technician may retrieve further information. Using color, symbols, and text, the technician is quickly and intuitively led to the desired technical information about the equipment. Each radio button 292 may have a color, text, graphic, photo, video, symbol, or combination thereof to display to the technician 222 quickly and easily what will be presented when the particular radio button 292 is selected.

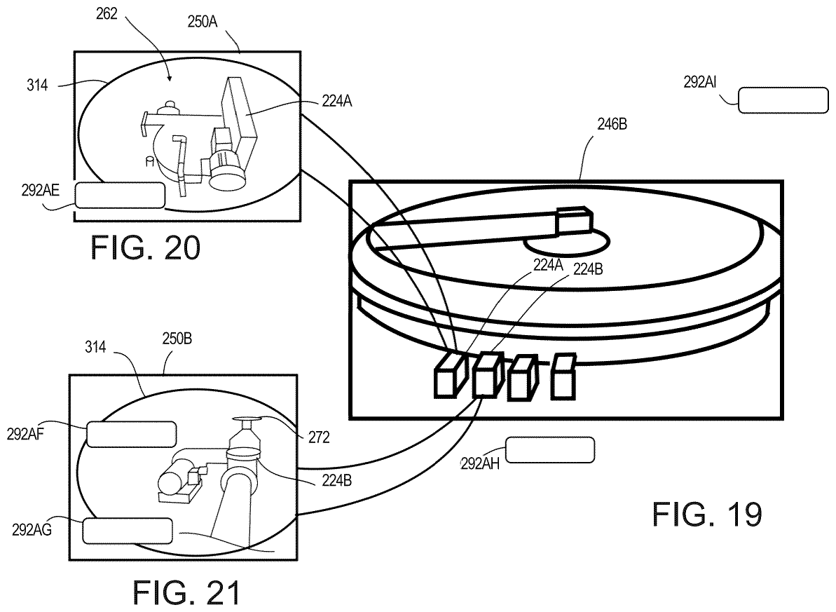

FIG. 18 shows the facility 226 of FIG. 17 with callouts and/or radio buttons 248 (248A-248B) for specific structures 246A and 246B respectively. When the proximity detection system 242 indicates that the technician 222 is in or near the respective structure 246, or alternatively when the technician selects a structure radio button 248, the video display 234 may shift to an enlarged view (FIG. 20) of the structure 246B. The view of FIG. 20 may include equipment radio buttons 250A and 250B indicating particular equipment 224 (224A and 224B respectively). FIGS. 18 and 19 further show radio buttons 292 for access to particular information relevant to the facility 226 such as: 292P for a secondary SOP index, 292Q for plant O&M, 292R for emergency SOP's, 292S for permit(s), 292T for O&M library, 292U for a secondary video index, 292V for plant drawings, 292W for a process flow diagram, and 292X for an archive index. Additional radio buttons may be provided in this view for quick access to information relevant to a particular structure 246 (A/B) such as: 292Y for pump speed, 292Z for a variable frequency drive (VFD), 292AA for a graphical index, 292AB for pump speed, 292AC for a sludge pump, and 292AD for a graphical index. Radio buttons 292 may also be provided for quick access to associated information. Such radio buttons 292 as: 292AE for a clarifier drive diagram, 292AF for a secondary sludge pump O&M manual, 292AG for a sludge withdrawal checklist (fillable form), 292AH for a chemical dosing checklist (fillable form), and 292AI for a wastewater overview video.

When the proximity detection system 242 indicates that the technician 222 is near the respective equipment 224, or alternatively when the technician selects a radio button 250 indicating that they are near the respective equipment 224, the video display 234 may shift to an enlarged view (FIG. 20, FIG. 22) of the structure 246B.

Once the technician 222 is close enough to enact on specific instructions pertaining to the respective equipment 224, the mobile computer may provide such specific instructions on the mobile computer 228 via the output system 232.

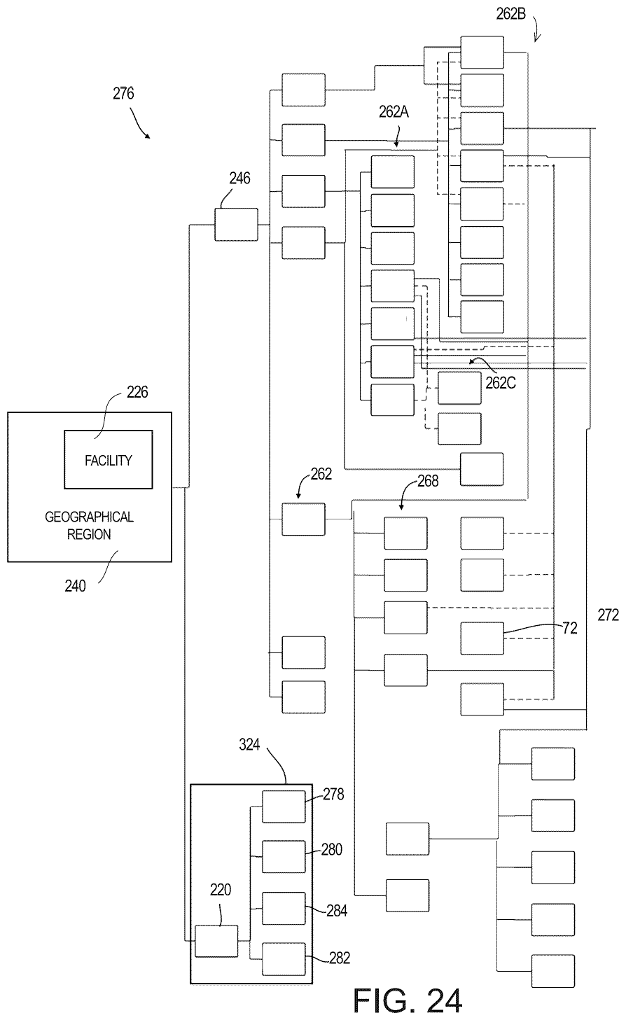

Disclosed herein are systems, methods, and apparatus related to equipment 224 maintenance and may include proximity association, data from location and sensors 268 to predicatively access a digital information system 220. This digital information system 220 comprises a multimedia digital database 252 as shown in FIG. 24 of maintenance data for equipment 224 in the facility 226 practice for field personnel (technicians). The digital database depicted in FIG. 24 may be characterized as a relational database but may be implemented by a graph database. A graph database may be suited for the relatively undefined, newly defined, and/or chaotic nodes and associations of a facility such as the facility 420 over time.

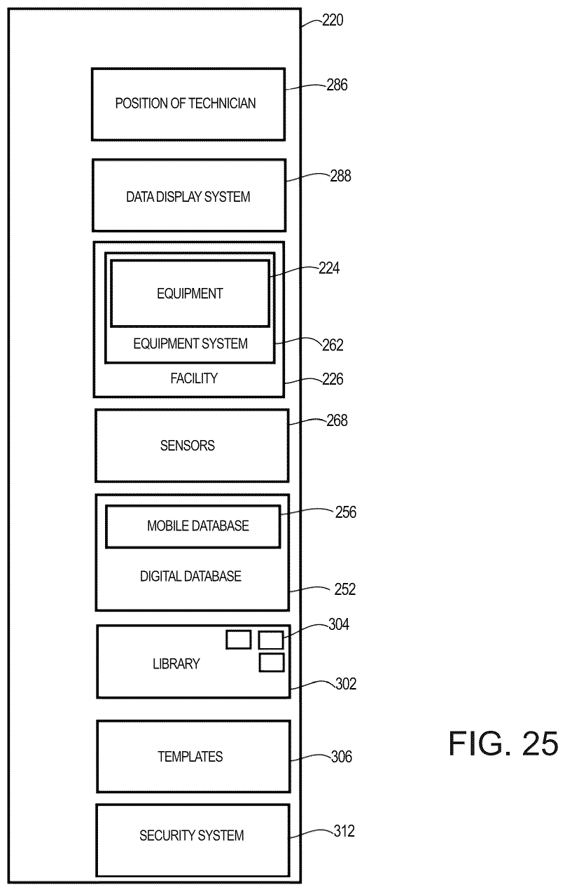

FIG. 25 depicts graphical index pages representing specific equipment systems 262A, 262B, and 262C (as called out in FIG. 24) and represents a method that may be used to illustrate the interconnection paths between information about each component of equipment. All of the boxes aligned with 262 are main processes within the treatment system such as Process tanks 1, 2, 3 . . . . Within each of these tanks, there is equipment performing some operation on the wastewater. The content relevant to the equipment is at level 262A. Discrete components worthy of documentation are at the next level 262B.

The information represented by each box in FIG. 25 is relevant to its parent piece of equipment and may also be relevant to other pieces of equipment. Access to this information from a second piece of equipment may not follow the same path as from the first piece of equipment. If uploaded content relevant to a pump type 1 to be included in a module for equipment A is relevant to another process or piece of equipment, a unique file is created for this information that applies to all equipment and not redundant locations that may not be contain consistent information. In that context, the return path is dictated by the access path. So if a user makes an inquiry about info for equipment A, taking steps backward and ending up in unfamiliar territory or within the info realm of equipment B should be avoided. Accordingly, the tree structure of FIG. 25 has some use for acquisition of information (e.g., filling empty spaces in a matrix), but the paths to access the information and ways that associations are created in the future is modeled by a graph database diagram and will typically not strictly follow a tree structure.

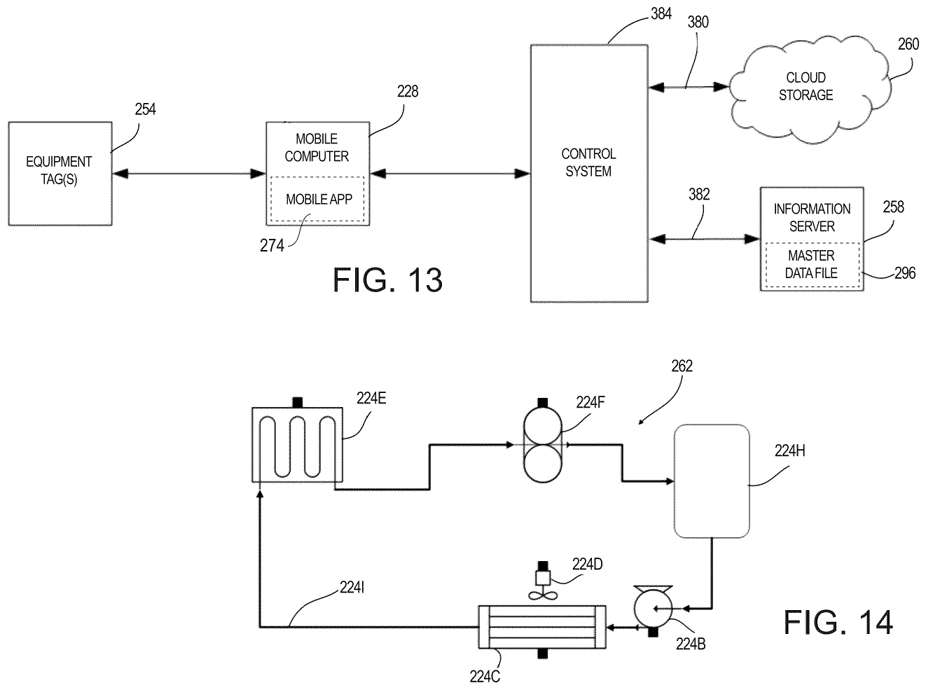

The database 252 in one example is indexed graphically and provides information about equipment 224 in the facility such as operation procedures, maintenance documents, technical drawings, maintenance history, training videos, troubleshooting analysis, data trends, etc. In one example, input from a local communication system comprising for example equipment tags 254, radio frequency identification (RFID) tags, Bluetooth transmitters, or other communications system provide real time and independent proximity association between the equipment 224 and the technician 222 in possession of a mobile computing device 228 such as a laptop computer, tablet, smartphone, etc. storing the mobile database 256 on non-transient media. In one example, the mobile database is a subset of the multimedia digital database 252 residing on an information server 258 as illustrated in FIGS. 13 and 22 and/or on cloud storage 260 as illustrated in FIG. 13.

The disclosed digital information system 220 in one example provides a multi-media platform and user interface on the mobile computer 228 to instruct the technician 222 about operation, maintenance and troubleshooting of complex equipment 222 and interconnected equipment systems 262. One example of such an equipment system 262 is shown in FIG. 14 comprising a pump 224B, condenser 224C, Fan 224D, pipe coil 224E, compressor 224F, storage tank 224H, and fluid conduits 2241 connecting inputs and outputs of each of these. As maintenance on any particular piece of equipment 224 in the system 262 affects downstream equipment 224, the digital information system 220 (as described below) in one example compiles data files 230 pertaining not only to the equipment 224 being maintained, but also the effects of maintenance on the particular equipment to other equipment in the equipment system 262. For example, maintenance on the pump 224B may put a higher throughput load on the condenser 224C. The digital information system may also compile data files 230 including possible causes of alerts to a particular equipment. For example, an alert to the condenser 224C may be caused by a failure in the fan 224D. Often, components come packaged in a larger unit such as an air conditioner. As a unit, interrelated information may be associated with one or more of the packaged components in the system documentation. On the other hand, in an industrial facility “units” typically comprise a plurality of components that are not prepackaged but are instead selected or chosen and designed to operate together by at least one plant employee, and typically a plurality of plant personnel, such as one or more engineers. Further, the components of an industrial facility may be selected and operatively connected over time.

In one example, the digital information system 220 is accessible through the graphical interface 234. This graphical interface 234 may comprise instructions 264, video instructions 266, and may cooperate with the audio output 236 to provide audio instructions as well as the tactile feedback (vibration) 238 to instruct and/or alert the technician. The graphical interface 234 may also comprise a technician input region 268 where the technician may add notes, provide feedback, and/or answer questions.

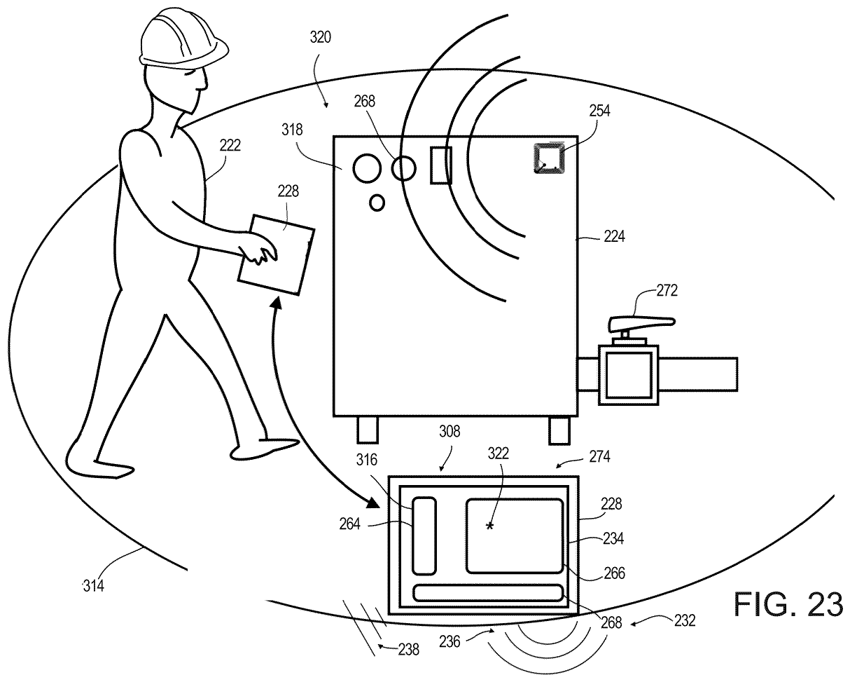

In one example of the digital information system 220; individual sensors 268 on or near the equipment 224 collect information about the functioning of the equipment 224. These sensors may detect operating parameters of the equipment 224 such as pressure, temperature, levels, and concentrations of chemicals in a fluid. This sensor data in one example is available in central locations 270 such as a control booth remote to the equipment 224 as well as on mobile computer(s) 228 which may be transported to the equipment 224 during maintenance. The data from these sensors 268 in one example is accessible through the graphical interface 234 of the mobile computer 228. In the current state of context driven data access, the technician 222 must know their position amongst the equipment 224 as well as know the context of the equipment 224 in the process of the associated equipment system 262 for example overall plant/facility 226/structure 246 to retrieve the needed information for safe and efficient maintenance. For example, as generally depicted in FIG. 23, a technician 222 may not understand the overall effect of changing the position of a particular valve 272 on an equipment 224B relative to an adjoining equipment 224A which is part of the same equipment system 262 in the structure 246B and facility 226. In contrast, conventional industrial control systems do not integrate the data from these sensors 268 into a multi-media platform on mobile computers 228 for operations, maintenance and/or troubleshooting for technicians 222 (field personnel).

The systems disclosed herein includes in one example a method of providing technicians 222 with the information they need to maintain, operate, asses the status, and troubleshoot equipment 224 forming an equipment system 262 such as a structure 246, and/or facility 226.

The term “maintain” in several variations is used henceforth to encompass at least one of: repair, operate, troubleshoot, asses the status of equipment 224, and equivalents. This method in one example comprises: a platform such as mobile computer 228 for storing and accessing data relevant to operating, maintaining, troubleshooting, or checking the status of equipment 224 within the facility 226. This data presented to a technician 222 in the field in one example as graphical data (e.g. photo or video) representative of the equipment 224 within the facility 226 displayed to the technician 222 on the graphical interface 234. The digital information system 220 in one example comprising a multimedia digital database 252 populated with user data files 230. The user data files 230 may be sorted by relevance based on context, chronology, and/or spatial relationships within the equipment system 262 to determine whether the equipment 224 forming the equipment system 262 (e.g. facility 226) are operating within parameters associated with the user data files 230.

The digital information system 220 in one example provides the technician 222 immediate and on location access to detailed information for operations, maintenance, troubleshooting, for the equipment 224 at the equipment 224 where it is most needed. The digital information system 220 in one example is populated by the technician 222 or other individuals for use by the technician 222 at the site of the equipment 224 to be maintained. The term “technician” as the term is used herein includes one person or a group of persons that are working with the equipment system 262 that require operation adjustment, maintenance, status check, and/or troubleshooting. Equipment systems 262 of may be stand alone or combined into system processes such as the structure 246 or facility 226 or even between adjacent facilities as shown in FIGS. 4 and 5. Information including, but not limited to, field and maintenance reports, field videos of procedures, audio files, and the like may be collected by field personnel and uploaded to the digital information platform. The disclosed digital information system 220 is configured in one example to mimic how the human brain thinks, learns, access information, and transfers that learning to others. This digital information system 220 disclosed herein has been developed through testing and implementing with technicians 222 and other concerned individuals and organizations.

The mobile application 274 (mobile app) view of the flow of information from the facility 226 level, to the structure 246/subsystem levels, then accessing discrete data files 230 about equipment 224. In one example the file may display to the technician 222 a multimedia procedure on the graphical interface 234. The procedure for example may explains steps via text instructions 264 and supplement concepts with pictures, audio, and video 266. Videos 266 integrate technical information such as design information from an engineer, with the more experience-based information of those involved in operation, maintenance, and status checks of equipment 224. The digital information system 220 in one example captures and compiles information for a facility and provides it in a predictive manner to the technician 222. In one example options are presented to the technician 222 in the manner of radio buttons (e.g. 244). Predictive access to files 230 including for example operations and maintenance manuals may be displayed to the technician 222 as they approach the equipment 224 as determined by logical programming, or the proximity detection system 242 or other methods such as by a query on the mobile computer 228 by the technician 222. These files 230/manuals may be interactive, word searchable, may be provided with hotlinks for the most common accessed information, and interlinked to information systems such as process flow diagrams 276 and process and instrumentation diagrams for associated equipment 224 in the equipment system 262, structure 246, and/or facility 226.

The multimedia digital database 252 of the digital information system 220, may be compiled and edited as a technician 222 incorporates/adds information to the system/subsystem levels 226/240/246/262/224. FIG. 22 discussed below illustrates one example of an algorithm illustrating the process of compiling and interlinking a database and displayed the process to the technician 222 on the mobile computer 228.

As perhaps best shown in FIG. 10, files 230 comprising operations steps 278, maintenance steps 280 and troubleshooting steps 282 may also be provided in a predictive manner via the digital information system 220. Access to multimedia support information, operations and maintenance information may be provided from manufacturer, procedures, next steps, contact information, parts reordering information, and forms 284 that may be fillable on the mobile computer 228 to document completion of task or request parts reordering. Alerts and work orders may be provided from an equipment management subsystem of the digital information system 220.

The digital information system 220 disclosed herein in one example sorts data files 230 by relevance based on context, chronology, and/or spatial connections, and becomes a guide for leading a technician 222 to understand when, why, and how to perform tasks and how these tasks may affect adjoining equipment in the equipment system 262 interoperating with the equipment 224 to be maintained by the technician 222.

The digital information system 220 in one example emulates the flow of learning and knowledge transfer to an individual and provides the technician 222 with relevant data in one example in real time at the location of the equipment 224. The technician 222 is then better prepared to think critically about how equipment 224 within each equipment system 262 relates to associated equipment 224 within the equipment system 262 such as the facility 226, what are the considerations that determine the normal functioning of the equipment 226, what are the considerations outside of that normal functioning, and what is needed for operations, maintenance, and troubleshooting of the equipment 224, and how should the technician 222 perform the next step of inspection, maintenance, or operation of the equipment 224 without detriment to the maintained equipment 224 or associated equipment in the equipment system 262.

One example of the digital information system 220 presents/displays a graphical image or map of the facility 226 as shown for example in FIGS. 17-21. A graphical representation of the equipment system 262 or facility 226 is shown with easy recognition as to a position 286 where the technician 222 is located. The graphical images presented may also include views such as video or photos or a description.

As used herein, the term “system” is defined as a combination of equipment, information, and equipment 224 that work together to take an “in” to the overall system and an “out”. The “in” is often defined by parameters recognized in the individual type of the process such as total flow, quality parameters, peak flows, type of flows. The “out” from the overall process is often defined by a permit, laws, design requirements, or standards. There is an understanding at this level of the direction of flow, the assembly of processes and equipment that make up each equipment system 262. Information about operations 278, maintenance 280, or troubleshooting 282 of individual equipment 224 may be directly accessed from this level. Equipment systems 262 are defined by the equipment 224 that work together with an “in” and “out”. Equipment systems 262 may be shown by a graphical representation e.g. schematic control diagram, photo or video so that there is an understanding of direction of flow, the assembly of processes and equipment 224 that make up the overall equipment system 262, and the defining criteria of projected or required standards for “in” and “out”. Any individual/independent pieces of equipment 224 not associated with any connected equipment system 262 but in the proximity of the equipment system 262 may be represented from the equipment system 262 graphic. Selection of a radio button or equivalent of an equipment system 262 can lead the technician 222 to adjoining or connected equipment systems 262 with interoperating individual pieces of equipment 224 making up each equipment system 262. Equipment systems 262 may be graphically accessed based on the graphical interface 234 with the technician able to view their current location and seeing a picture, photo or a 360-degree video of equipment 224 within their field of view.

II. Creating Digital Information System on Mobile Computer within Mobile Application on Mobile Computer

One method of compiling the digital information system 220 is within application software 286 shown in FIG. 25. As shown in FIG. 25, the multimedia digital database 252 and optionally the data display system 288 can be compiled and customized by the technician 222, supervisor, or another user using the tools provided in the application software 286. In one example this compiling can be accomplished on the mobile computer 228. The term “user” here refers to a person or persons including for example a technician, with a computing device creating, designing, using, or implementing digital data system. Using one example of the multimedia digital database 252, the user creates or uses and existing digital information system 220 on the mobile computer 228 or other user interface terminal configured that the user may create and or utilize the digital information system 220.

Data files 230 of types comprising pdf, jpg, mpg, text, audio, video, and/or other files to be utilized by the technician 222 may be stored on in the digital information system 220. These data files 230 can be added by a user manually, through other applications, or through a communication connection with the graphical interface 234 via, URL, RFID, Bluetooth, email, or other systems, devices, and methods from the multimedia digital database 252 to the mobile database 256.

The digital information system 220 in one example is an interlinked data management system, linking connected and interoperating equipment 224 and equipment systems 262 for easy access and understanding of maintenance needs of the equipment 224 and effects of maintenance on other connected/interlinked equipment 224 within each equipment system 262, facility 226, and structure 246. In one example the digital information system 220 provides an intuitive graphical interface 234 for the technician 222 to retrieve information (data files 230) about equipment 224. In one example the technician 222 begins a maintenance session by viewing the overall facility 226 image as shown in FIG. 17. Alternatively, the technician 222 could be brought directly to the system or subsystem page using data indicative of the location of the technician 222 or the interaction of the technician's mobile device 228 with a nearby RFID tag.

The system or subsystem page could be simply a photo of a particular facility 226 or region of the facility 226. In one example, the technician may then select a main index 290. This main index 290 may comprise radio buttons 292 (see, e.g., FIG. 12) which are labeled and located to define equipment systems 262 and/or infrastructure systems 292, such as a water system radio button 292A, sewer system radio button 292B, gas system 292C, or specific equipment 224 such as wetwell radio button 292D, pump radio button 292E, and control radio button 292F. In one example, the technician 222 selecting a particular graphic or selection of groups of equipment 224 displays to the technician more information and information selection options regarding the selected choice. Selection of viewing of individual equipment 224 in one example presents to the technician a close-up graphic of the selected equipment 224 as shown for example in FIGS. 21 and 22. Data files 230 including operation and maintenance manuals, procedures, videos, pictures, audio files can be added, labeled with radio buttons, and linked by the multimedia digital database cooperating with the mobile application 274.

The digital information system 220 in one example is stored on a mobile device/computer 228 such as an iPad®, laptop, smartphone, or other mobile computer 228. In one compilation method, additional data files 230 may be linked or added with a ‘dragging’ motion of the technician's finger and a ‘dropping’ of a piece of information in the format of pdf, jpg, or video, 360 degree video at the point with a tap of the finger of graphical association of subsystem, equipment in questions. Such dragging and dropping action is known in the field of computing. Thus, a connection is made between the data file 230, the radio button, the labeling of the radio button, and the location of the radio button. This data file 230 can be dragged and dropped repeatedly as needed on other layers, within operations and maintenance manual, within standard procedures building the interlinked, easily accessible digital information system 220.

In one example data files 230 are available to drag and drop or otherwise be added, connected, or retrieved is loaded into the mobile database 256 on the mobile computer 228. As it is ‘dragged and dropped’ the database in one example develops a flow chart 294, showing the layers of information and flow of information among the layers.

In one example shown in FIGS. 4 and 5, the graphic representing a facility 226, equipment system 262, or equipment 224 is shown with a radio button (e.g. facility radio button 244, structure radio button 248, equipment radio button 250) and labeled with the information associated such as operations and maintenance manual, operating procedure, design drawing, permits, or module. The technician 222 in one example compiles the multimedia digital database 252 and/or mobile database 256. In one example these connections can be established in the database 252/256 without a live or active connection to the information server 258, cloud server 260, or external communication link 380/382 respectively to a control system 384.

In one example, a master data file 296 is hosted on a server 298 in non-transient media. This master data file 296 allows a remote backup of the multimedia digital database 252 and/or mobile database 256 and attached files 230 for later retrieval, copying, or other use. The server 298 of one example is configured to enable sharing the database 252/256 or parts thereof to others, downloading on other devices, creation of permissions, adding additional database structure such as precompiled equipment modules, or user templates. In one example a data link 300 to the backup server 298 such as a, local server, remote server, local computer, cloud storage, cloud storage on the internet, may be necessary to back up the multimedia digital database 252 and/or mobile database 256. This backup and retrieval process may be manually initiated by a user such as the technician 222.

The backup server 298 of one example is secured using technology such as secure socket layer (SSL) or transport layer security (TSL). The security system may be updated as new technology becomes available. Similarly, the mobile computer 228 may be secured using the technology available on the mobile platform such as access codes, voice recognition, and fingerprint identification. In one example, RFID technology and components may also be used for security before, during, or after transferring data from the proximity detection system 242 or conditional sensors 268.

In one example, a library 302 of precompiled modules 304 for common equipment 224, sensors 268, procedures, process expert information are available for, download, and association with the equipment 224. The technician 222 can download, purchase, or otherwise acquire these and other modules 356 for easy implementation into or compilation of the digital information system 220. The modules 304 may be added to the multimedia digital database 252 on the information server 258 or backup server 298 for the technician 222 to easily access. The technician 222 can download these modules 304 or portions thereof onto the mobile computer 228 and connect these modules 304 to other equipment files 230 in the mobile database 256.

In one example, templates 306 are available for download to the mobile application 274 from the information server 258, cloud storage 260, remote computing device, backup server 298, etc. These templates 306 may include user interface (UI) formatting to simplify the creation of the digital information system 220 in the mobile application 274 including formatting, graphics, systems, workflow, and radio buttons.

One method of adding files 230 and creating connections between files representing specific equipment in the digital information system 220 is provided by the mobile application 274 or associated software resident on non-transient media where the digital information system 220 can be compiled and customized by the end-user/technician 222 using the tools provided in the application software 286. In one example this may be accomplished on the information server 258 or another computer for later implementation on the mobile computer 228. This application software 286 in one example is configured to accept input from other third-party software to create the user interface graphics 308 on the graphical interface 234 as well as customize the digital files 230 and procedures of the multimedia digital database 252. The actual compilation of the digital information system 220 in one example is accomplished within the application software 286. Using the master data file 296 provided on the information server 258, cloud storage 260, or backup server 298 the technician 222 compiles the digital information system 220 and then downloads the data files 230, database structure, and operating system, to the mobile computer 228. These data files 230 may include pdf, jpg, video files, and others. These data files 230 can be added manually, through other software applications, or through a connection with the control panel URL, RFID, Bluetooth, or email. In one example, the digital files 230 are moved into the mobile application 274. Using the mobile application 274 each file 230 can be viewed on the graphical interface 234.

The digital information system 220 in one example is a contextually accessible data management system rather than a relational data base. This digital information system 220 may provide a graphical and intuitive process to retrieve information about equipment and connected equipment faster and more efficiently than relational systems. In one example an overall system or facility 226 graphic (e.g., FIG. 17) is displayed to the technician. This graphic may be a photo, map, diagram, or combination thereof and may include textual and audio indicators of the equipment system 262 or facility 226. From this view, the technician 222 may make selections, for example via radio buttons 248 which are labeled and located to define subsystems, structures 246, equipment 224, equipment systems 262, etc. Selection of these radio buttons 250 lead to further graphics of groups of connected equipment, equipment systems 262, individual equipment 226, etc. In one example, selection of an individual equipment radio button 250 leads to a close-up graphic and/or description of the equipment 224 as shown in FIGS. 20 and 22. At any time, data files 230 including manuals, procedures, videos, pictures, audio files can be added, labeled with radio button, and linked by the mobile database 256 for access via the mobile application 274.

The digital information system 220 in one example is built with a ‘dragging’ motion of a mouse or pad known in the field of computer interaction, and a ‘dropping’ of a piece of information in the format of pdf, jpg, or video, 360° video at the point of graphical association of equipment system 262, equipment 226 in review for maintenance. In one example, during use a connection is made between the data file 230, the radio button 244/248/250, the labeling of the radio button, and the location of the radio button. In one example, each data file 230 can be dragged and dropped repeatedly as needed on other layers, within operations and maintenance manual, within standard procedures building a contextual accessible data management system.

The information that is available to drag and drop may be placed or move within the software application. As it is ‘dragged and dropped’ the multimedia digital database 252 develops a flow chart (see, e.g., FIG. 24). In one example, the flow chart is accessible visually on a graphical interface 234, showing the layers of information and flow of information among the layers.

The facility 226, structure 246, equipment system 262, equipment 226 may each be marked with a radio button and labeled with the information/data file 230 associated such as Operations and Maintenance Manual, Operating Procedure, Design Drawing, Permits, or Module. The technician thus compiles the multimedia digital database 252. A server may be utilized to host (store) this multimedia digital database 252 on non-transient media on the cloud, a computer, tablet, smart phone, or combinations and equivalents thereof. This allows a download and syncing of the multimedia digital database 252 or a portion thereof to the mobile application(s) 274, and backup of the multimedia digital database 252 and attached data files to the master data file 296. The server may allow sharing to other users, downloading on other devices, creation of permissions, adding additional features such as precompiled equipment modules 304, or user templates 306. The connection to the internet may be utilized to access the backup server 298 and may be manually initiated by user.

The backup server 298, information server 258, cloud storage 260, may be secured using technology such as secure socket layer (SSL) or transport layer security (TSL) using a security system 312. The security system 312 may be updated as new technology becomes available. The mobile database 256 and mobile application 274 may be secured using technology available on the mobile computer 228 such as access codes and fingerprints. RFID will also be used for security before transferring data files 230 or portions thereof from proximity or conditional sensors.

### III. Predictive Data Access of Digital Information System

While in the field at a facility 226 such as a treatment plant, or other environment with distributed mechanical or electrical equipment 224, the technician (User) 222 has access to a mobile computer 228 such as a smart phone, smart watch, tablet. In one example the technician 222 receives messages or alerts on the mobile computer 228 related to equipment within a pre-determined proximity 314. This may be determined as a visual range, specified distance, or other measurement. In one example a proximity of 20′ allows the mobile computer 228 to receive a signal from the proximity detection system 242 and respond while likely in visual range of the indicated equipment 224 where they can perform needed maintenance.

In one example, messages 316 to the technician are generated based on predictive programming using the location of the technician 222 in proximity 314 to the equipment 224, permissions allowed to the technician 222, and data collected by devices such conditional sensors 268, and/or data communication from control panels 318. The predictive programming parameters may be determined by the technician(s) responsible for operating, maintaining, and troubleshooting the equipment 224. The messages 316 may be provided via screen notifications on the mobile computer 228 to which the technician 222 may respond by acknowledging the message prompting. The technician 222 may not necessarily required to respond to prompts as they move among other equipment 224 within the active proximity that result in prompts on the mobile computer 228 associated with the equipment documentation data file 230. Acknowledging prompts may initiate pre-determined actions within the mobile application 274 on the mobile computer 228. In other examples the multimedia digital database 252 or a portion thereof such as the database subset for a facility 226, structure 246, or an equipment system 262 is available and resident on the mobile computer 228 for manual or automatic access of support information including data files 230 for equipment in the mobile database 256. This system provides the technician 222 with necessary information about interconnection between the equipment 224 they are maintaining and the rest of the facility 226 or a subset thereof.

When the proximity detection system 242 determines that the mobile computer is within the proximity 314 to equipment 224 needing maintenance, the technician 222 may be altered to an acknowledged prompt (e.g. radio button) may initiate access to a data file 230 on the mobile computer 228 that is relevant to nearby equipment 224. The data file 230 presented to the technician 222 may be associated with a scheduled operation or maintenance activity.

Prompts may also be initiated based on pre-determined conditions such as time (i.e., frequency of a maintenance task) a preceding action, or an input from another source.

Proximity identification may be facilitated through the proximity detection system 242 including for example a specific equipment RFID tag 254. One such equipment tag may comprise a radio frequency identification (RFID) tags located on or near the equipment 224. Proximity identification may also be facilitated through Bluetooth® radio wave technology connecting with mobile computer 228, and other methods and equipment. The mobile computer 228 may be configured to communicate with an RFID reader or Bluetooth device, which provides input to the mobile application 274 (app) on the mobile computer 228 to indicate that the technician 222 is within the proximity range 314. The proximity input may result in the mobile application 274 generating messages 316 on the graphical interface 234 of the mobile computer 228 that, if acknowledged, provide access to or push to the technician relevant data files 230 which may include options to view adjacent equipment information such as associated equipment 224 in the same equipment system 262 on the mobile computer 228. Proximity sensors may provide supplemental data to the mobile computer 228 more than proximity/relative location of the mobile computer 228 to the equipment 224. This supplemental data may include equipment identification, date of last query, date of last maintenance, individual equipment identification, time, and a record of prior queries.

Sensor inputs from the equipment tag 254 to the mobile application 274 may include sensor inputs from a plant supervisory control and data acquisition (SCADA) system. The SCADA system may provide an input to the mobile application 274 indicating a condition outside of a pre-determined value or set point. Individual points of data can be collected by a simple sensor system 230. The sensor input may trigger an action or alert associated with the technician 222 being in proximity of a particular equipment 224 with a conditional sensor 268 reading a status that indicates the equipment needs maintenance. In this case, the technician 222 may receive a prompt via the mobile computer 228 when the mobile computer 228 is in the proximity 314 of the particular equipment 224, regardless of prior routine checks.

For example, a SCADA input to the mobile application 274 may indicate that a fluid tank level has been filling more slowly than usual. The technician is prompted to check a pump 224B (FIG. 14) that fills the tank, by providing specific information related to the condition indicated by the SCADA system. This may be an instruction (text, graphic, or video) to verify the pump 224B performance by checking pressure, flow, and power consumption, then to compare to the pump performance curve, which may be provided to the technical through the digital information system 220.

Upon completion of the maintenance on any equipment 224, the technician 222 may be prompted to complete a fillable digital form 284. This form 284 may be stored in a pre-selected location such as resident on the mobile computer 228 which then may be placed in a queue for emailing, or uploaded to the server 258 or cloud storage 260 when the mobile computer 228 is in data communication with the information server 258, cloud storage 260, or backup server 298.

In another example, a technician 222 such as an industrial plant operator, travels through the facility 226 in performance of their daily duties. As the technician 222 travels within a pre-determined proximity 314 (i.e. 10-15 feet) of an equipment such as a pump 224B, an alert is sent to the technician 222 on the mobile computer 228 to review appropriate data files 230 and perform maintenance related to the equipment 224. If documentation of the duty is required on a form 284, the input to the form 284 may be manually or automatically input by the technician on an input region 268 of the graphical interface 234. In one example, user defined settings on the mobile application 274 determine what prompts 322 and data files 330 are sent to the technician 222. If an operation or maintenance activity is pending or due, the documentation for the activity may be made available on a graphic index page 324 within the mobile application 274.

Data files 230 may include operation and maintenance manuals, video, graphic, or text descriptive pages, or combinations thereof all in digital file formats. The technician 222 accesses these data files 230 resident in non-transient media on the mobile computer 228 to avoid dependence on potentially limited data transmission connectivity within the facility 226, or structure 246 (typical in industrial environments). Digital forms 284, which contain active and static fields, may be filled by the technician 222 by acknowledging prompts 322 or by input for example through a keyboard, buttons, by voice, or voice to text.

Continuing this example, as the technician 222 travels through the facility 26 after performing daily duties, within proximity 314 of the same pump 224B noted above, they may not be prompted with offers for information related to daily operations, as the RFID query and response history persists within the mobile application 274.

### IV. Control Panel Monitoring Sites for Accessing Predictive Information on the Digital Information System

As shown in FIG. 23, control panels 318 may be provided on individual equipment 224. In one example, control panel monitoring sensor output interfaces with a human machine interface (HMI) or mobile computer 228 which include video displays (graphic interface 234), mice, touchscreens, touchpads, audio input and output devices, etc. This HMI allows monitoring and data access in one example through URLs associated with control system tags (e.g., addresses). Each panel may have a remote access router 326 (see, e.g., FIG. 10). The portable computer 228 portion of the digital information system 220 is positionable near the equipment 224, equipment system 262, or subsystem that is monitored and controlled by a specific control panel 318 and may be in communication therewith to transfer information from the conditional sensors 268. Data communication from the control panel 318 may be available from the panel, typically via a SCADA computer system or, alternatively, a File Transfer Protocol (FTP) site. Based on Peripheral Interface Controller (PIC) programming, certain trends, maintenance triggers, sensor outputs, and other data collected by the control panel trigger a query into and access to the context driven data system. Whereby operations, maintenance or troubleshooting information may be provided on the mobile computer 28 located near the control panel 318.

### V. Operations, Maintenance, and Troubleshooting Next Steps

As the digital information system 220 compiles, information is collected from the technician(s) 222 modules 304 may be added and interfaced with the Operations, Maintenance, and Troubleshooting Index Pages 324 as generally depicted in FIG. 24. These pages 324 include information from other sources, including engineering, regulatory (e.g., permits), and manufacturing and service to organize access to these data files 230 including data files 278-282 and fillable documents 284. In the state of the art, these manuals are accessed via a list, tree-structure table of contents, or the like. However, these manuals typically assume that the user has pre-existing knowledge for effective navigation of the manuals to find appropriate information contained within the manuals. The digital information system 220 of one example allows access from the index pages 324, system or subsystem, maintenance requirements or possible troubleshooting solution. Access may be facilitated from within the operations and maintenance manual to supporting procedures, other supporting manuals, or other related subsystems.

### VI. Mobile

Developed exclusively for mobile use, the digital information system 220 disclosed herein is created for accessing information and procedures for operations, maintenance, and troubleshooting of equipment 224 and in one example is completely resident on the mobile computer 228, independent of a web connection or other data transmission when in use in the field. The multimedia digital database 252 may be edited, revised, supplemented directly on the mobile computer 228. A web or other data transmission connection may be utilized when the original platform is updated with new equipment 224.

The mobile computer 228 may be configured to connect to the information server 258, cloud storage 260, and/or backup server 298 periodically. This data connection may be used to update and backup the digital information system 220, allow sharing with other users, as well as to edit user account permissions. An Internet connection may be utilized for this function.

### VII. Multimedia Procedures

Disclosed herein is a digital information system 220 configured for creating and/or accessing multi-media data files 230 including maintenance procedures and/or other siloed information for or associated with equipment 224. The digital information system 220 allows a technician 222, the creator of the procedure, and others to sort through the web of experience and leads to the creation of a repair/maintenance/operation procedure in a logical, methodical system. The digital information system 220 further facilitates the prediction of when performance of repair/maintenance operations by the technician 222 will be required. Data files 230 such as pictures and short video clips may be embedded in the procedure to explain and display first-hand experience to the technician of the sounds, smell, heat, observations over time, experience, understanding of the overall process, spatial and operational relationship and location of associated equipment. The multimedia provides nuances learned by an experienced technician with knowledge of or having previously performed the specific procedure. The multimedia data files 230 may be embedded into the procedure at the immediate point of discussion. The media data files 230 may be available yet optional to view and can also be viewed endlessly as needed. These procedures may also bring in additional expert references to support the procedure.

The procedures may be accessible on a mobile computer 228, available off-line (not immediately connected to the internet), and/or on a self-contained mobile information system that provides predictive information of when and why each procedure will be needed for operations, maintenance, and troubleshooting of equipment. Procedures accessible on the mobile computer 228 are available based on where the user is and what the user is doing, what has occurred in the past, and when these procedures are needed.

These procedures can be created within the app, including attachment of multimedia support files within the procedure.

The term “maintenance” used herein includes but is not limited to operation, repair, status, care, upkeep, support, viewing of equipment.

The term “technician” used herein includes workers, users, administrators, supervisors, and others interacting with the disclosed digital information system.

Referring back for a moment to FIGS. 4 and 5, FIG. 4 shows part of one example of the digital information system 220 depicting a first geographical region 240A for example the town of Able. The first geographical region comprises industries and infrastructure facilities 226, in this example including: manufacturing 226A, wastewater collection 226B, gas distribution 226C, transportation 226D, power generation/distribution 226E, water distribution 226F, and water treatment 226G. FIG. 4 also shows alternate geographical regions for example a town of Baker 240B, and a town of Charlie 240C.

Expanding on the water treatment facility 226G, with the digital information system 220, the technician 222 presented with a graphic of the town of Able 240A, may select a radio button 244G which displays a graphic of the water system 228 of the town of Able 240A. This graphic may include one or more structures 246 and one or more radio buttons 248 for these structures 246 including a water treatment plant site 226G radio button 244G.

Selection of this facility radio button 244G displays additional information relevant to the water treatment plant site 226G as shown in FIG. 4. For example, the town of Able water treatment building 246G, as well as other structures 246. Details including maintenance information relevant to the structure 246G may be accessed by selecting a facility radio button 244G representing the structure 246G. The technician 222 may also be presented with options to display user-community input from a user-community input system 330 regarding equipment 224 in common with others, such as in an equipment system 262. Such user-community input may include ratings, data/trends, procedures, links to modules, synthesized content, etc. In one example this showing a selection of the equipment 224 within the structure 246G including in this example a clarifier 224G with an associated equipment radio button 250G. Selection of this equipment radio button 250G presents to the technician 222 information selections such as a module 304 which may include: operations and maintenance procedures, troubleshooting procedures, feedback loop based on previous user experience, replacement parts, and probability-based links in documentation.

In one process flow example, an example of which is shown in FIGS. 4 and 5, selection of the equipment radio button 250G begins a process flow 332 with one condition/state where the user is notified and when the technician in in the area of the equipment 224G the technician 222 is then led to a process 334 where the state of the equipment 224G is that the unit is in “shutdown” mode. A following process flow 336 where the equipment 224G module indicates probably/priority item to check. This probability may be based on data records and lead to an action process 338 for the technician 222 to check the effluent turbidimeter. Leading to a process 340 indicating that the effluent turbidity is 0.3 NTU. This leading to a first cause 342A where it is determined that the treatment system is not working effectively. This first cause 342A result from 342B where it is determined that the influent turbidity has increased, which in turn was caused by 342C where there was a change in source quality or quantity or alternatively 342D of coagulant dosing or chemical type of problem. This cause 342D may result in a suggested action 344A from the digital information system 220 to contact the chemical vendor.

Alternate to the first cause 342A, it may be determined that a second cause 342E may be at fault; that the turbidimeter needs cleaning and calibration. This cause resulting in a module 304E being displayed; hatch module for turbidimeter having content 346. The module 304E may be accessed by other conditions/modules & communities.

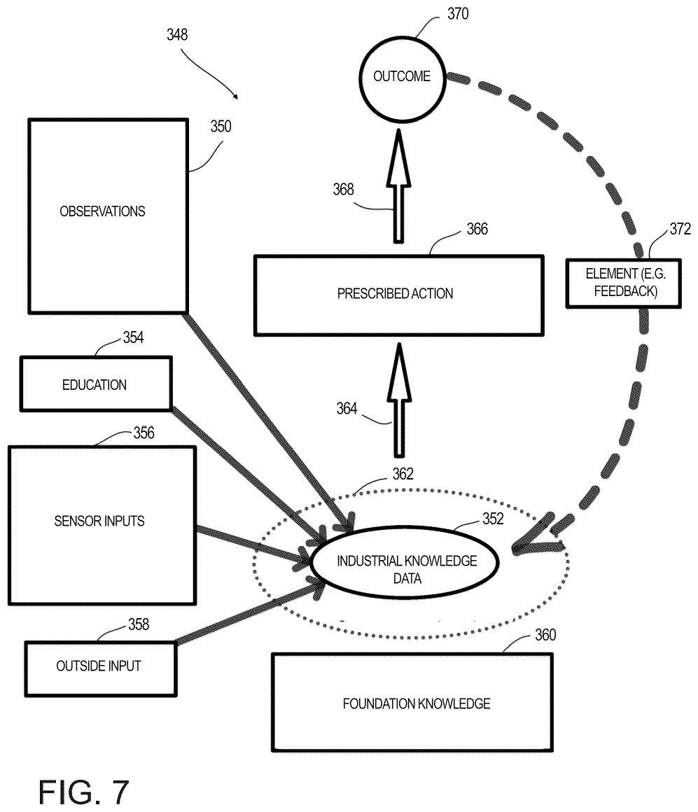

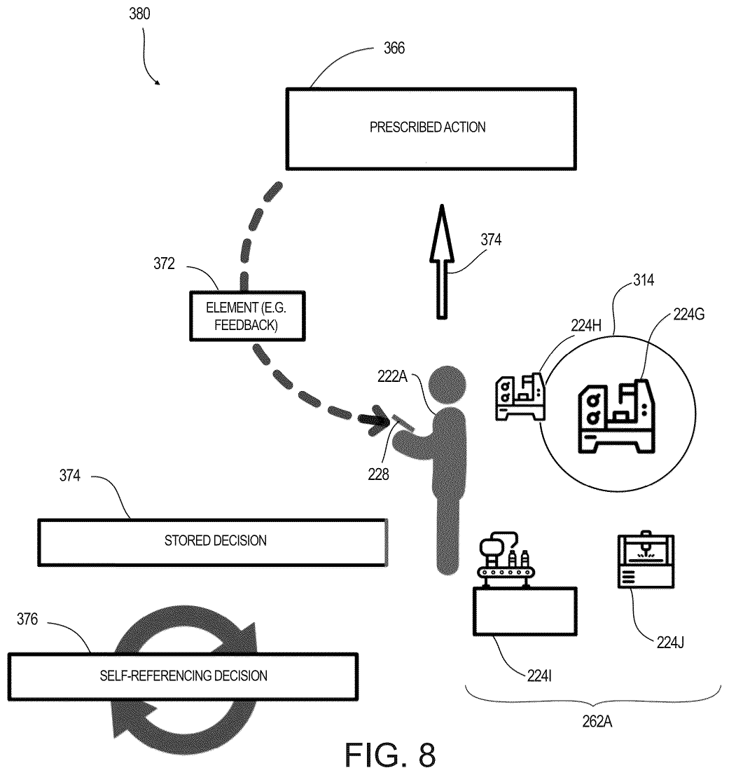

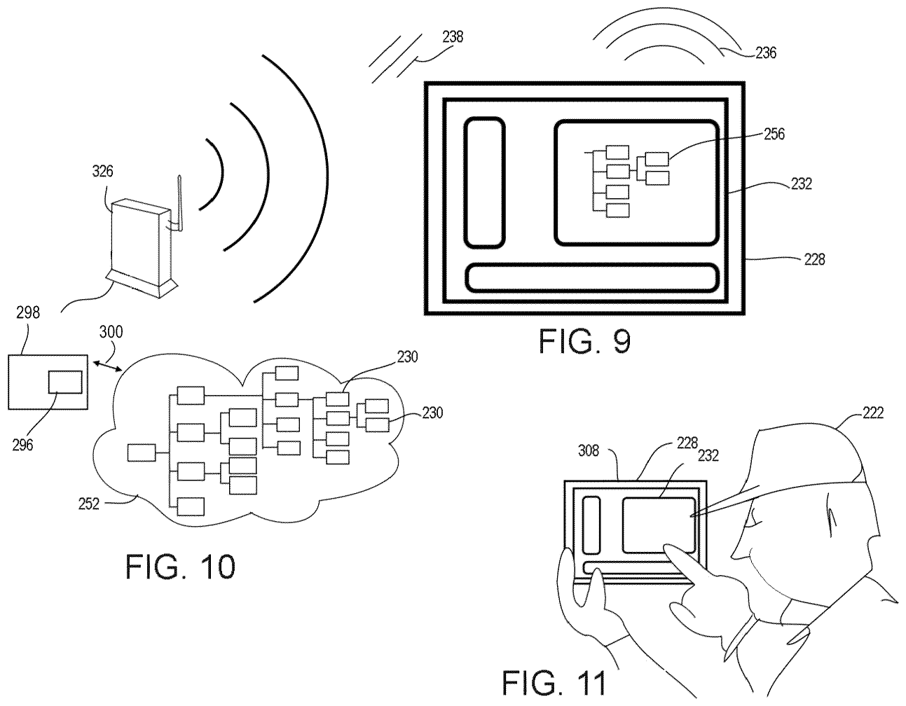

As perhaps best shown in FIG. 7 of the drawing, interconnections a data collection system 348 may emulate a learning process. The elements shown here may be included in the modules 304 and/or data files 230 comprising the multimedia digital database 252. One element may be observations 350 such as variables: context, conditions, prior experience; data collection; lab results, and identifying “normal”. These observations 350 may be included in the industrial (tribal) knowledge 352. Tribal knowledge is any (often unwritten) information that is not commonly known by others within a company. This term is used most when referencing information that may need to be known by others to produce quality product or service. Tribal knowledge is rarely included in the written manuals for equipment 224, facilities 226, and equipment systems 262 and includes interconnections to isolated (e.g., silo-ed) information and thus must be passed orally or may be lost as personnel are no longer available such as by promotion, retirement, or other reasons.

Another element may be formal continuing education 354 which may also be added to the industrial knowledge 352.

Another element may be sensor-derived inputs 356 such as for example: wired and wireless (radio) communication links, equipment (RFID) tags, widget data, SCADA info, alerts, and alarms. These inputs 356 may be derived from the conditional sensors 268 or others.

Another element 358 comprises other people's opinions.

Another element comprises foundations 360 such as for example basic training, mentor influence, and industry standards industry standards. These foundations 360 represent external influences unrelated to a specific system. These foundations 360 are, however, are underpinnings that allow the user to place specific system information in context.

the industrial knowledge data 352 may be included with constraints 362 such as regulations, laws, perceptions.

these elements 350, 354, 356, 358 are included in the digital information system 220 and provided with the mobile application 274 to determine a process flow 364 by the mobile application in cooperation with the technician 222 to prescribe an action 366 to the technician 222. The action 366 may include actions affecting operations, maintenance, troubleshooting, and/or emergency response.

The action 366 leading to another process flow 368 resultant in an outcome 370. The outcome 370 may result in an element 372 including feedback from the experiences of the action 366 and outcome 370, implemented in the industrial knowledge 352 of the mobile application 274.

FIG. 7 shows how these actions 366 and feedback 372 are included in the mobile application 274 presented on the mobile computer 228 to the technician 222 who may be a new employee 222A with little or no experience on the particular equipment 224. As the technician 222A approaches the equipment 224G and enters the proximity range 214, the proximity detection system 42 triggers the mobile application to display to the technician 22A information relevant to the equipment 24A and/or equipment system 62A.

The technician 22A then makes a maintenance decision 174 resulting in an action 166 and the digital information system 20 stores the decision 174, action 166, with other information as a self-referencing (recursive) information path 176.

One element 178 of the person-centered decision-making algorithm 180 of the digital information system 20 is stand-alone functionality of the mobile computer 28. Thus, the mobile computer 28 does not rely on any communication (internet, radio, WIFI, Ethernet, cellular, etc.) communication to exterior devices or databases to operate within the proximity range 314.

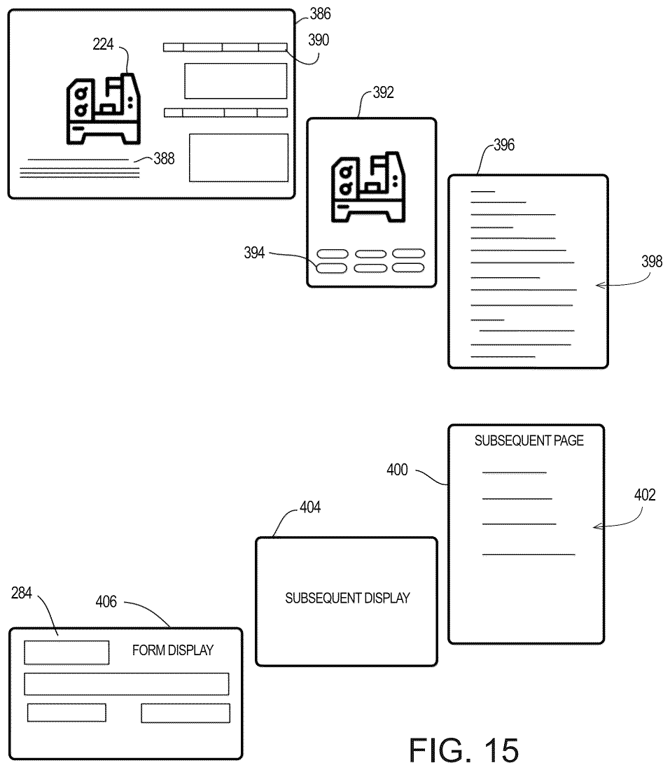

FIG. 15 shows one example of a flow of information where a first display page 386 relevant to a particular equipment 224 in one example includes a description 388 of the equipment 224 and options 390 for additional information. Selection from this display page on the mobile computer 228 displays a second page 392. This second page 392 also includes information and further options 394. In one example either page 390/392 leads the technician 222 to a third page 396 which includes quick access selections and information 398. Selection of an appropriate screen element displays to the technician a subsequent page 400 including instructions 402, optionally with multimedia support for difficult tasks. This multimedia may include video/audio/text knowledge on a subsequent display 404. A fillable form 84 may be displayed on a subsequent form display 406 as previously described when the maintenance task is completed.

As shown in FIG. 22, a data transmission system 408 may facilitate communication between the mobile computer 228, multimedia digital database 252 equipment tag 254, and backup server 298. In one example a communication link 410 allows the mobile computer 228 to ping off the equipment 224, particularly the equipment tag 254. The equipment tag 254 in response via a communication link 412 send identification and data back to the computer. This data may include sensor data from the conditional sensors 268. For example, an RFID tag is capable of sensing a capacitive/resistance variance as the technician 222 touches or is in close proximity to the RFID equipment tag 254 and relaying this change to the mobile computer 228 via the communication link 412. Thus, if the technician touches a valve with an attached RFID tag, the RFID tag can relay the change in capacitance arising from the touch to the mobile application 274 and thus determine if the technician has actually grasped the correct valve and send an alert via the output system 232 to the technician via visual, audio, tactile output, or a combination thereof.

Ping is a computer network administration software utility used to test the reachability of a host on an Internet Protocol (IP) network. It is available for virtually all operating systems that have networking capability, including most embedded network administration software. Ping may be used to measure the round-trip time for messages sent from the originating host to a destination computer that are echoed back to the source. The name comes from active sonar terminology that sends a pulse of sound and listens for the echo to detect objects under water.

Ping in one example operates by sending Internet Control Message Protocol (ICMP) echo request packets to the target host and waiting for an ICMP echo reply. The program reports errors, packet loss, and a statistical summary of the results, typically including the minimum, maximum, the mean round-trip times, and standard deviation of the mean.

The command-line options of the ping utility and its output vary between the numerous implementations. Options may include the size of the payload, count of tests, limits for the number of network hops (TTL) that probes traverse, interval between the requests and time to wait for a response. Many systems provide a companion utility ping6, for testing on Internet Protocol version 6 (IPv6) networks, which implement ICMPv6.

A data link 414 is established between the mobile computer 228 and the multimedia digital database 252 when available. The mobile computer 228 uses this link 414 to ping the information server 258/cloud storage 260 storing the multimedia digital database 252. When established, needed data files 230 are sent via communication link 416 from the information server 258/cloud storage 260 to the mobile computer 228 for updates. These data files are maintained on the mobile computer 228 on non-transient media for access when the communication links 414/416 are not available. As previously mentioned, the data link (data communication connection) 300 between the information server 258/cloud storage 260 and the backup server 298 such as a, local server, remote server, local computer, cloud storage, cloud storage on the internet, may be provided to back-up the multimedia digital database 252 and/or mobile database 256.

One method of operation of one example of the disclosed digital information system 220 comprises the steps of:
Step 1: Collect available information about the facility, operation or system. This may include procedures, technical manuals, operation and maintenance information, plans, material safety data sheets (MSDS), flow diagrams, construction documents, reports, permits, etc.
Step 2: Assemble the collected information into a database structure that is analogous to a graph database. Subdivide information into small units of information (nodes).
Step 3: Based at least in part on source (e.g., function, type, or relevance), associate between nodes based on the source of the information. Receive data from Subject Matter Experts (SME) to pre-associate information on an advanced level.
Step 4: Prepare graphically based human-machine interface (HMI) screen for the technicians on a computing device which may be mobile (e.g., phone or tablet).
Step 5: Provide input mechanism for user to input information from local sources and observations and organize it by association. Association may be made by gestures on the HMI or by other input methods on the mobile device.
Step 6: Update the digital information system nodes and associations through standard connection protocols. This update may include:
Sensors (i.e. standalone Internet of Things, Bluetooth, or within overall control system);
RFID tags;
Inputs/Outputs from Programmable Logic Controller (PLC) (e.g. access by address SCADA software such as Wonderware or FactoryTalk);
Lab data (e.g., output from lab data software such as Hach Wims);
Maintenance Management System data (e.g., output from Maximo);
Weather data (e.g., collect from widget);
Captured information from communication (data extraction from text and emails);
Data Historian info for inputs to SCADA server;
Location from GPS on user mobile device;
Sensors on the mobile device apps (e.g., Sound spectrum analysis on Signal Scope, Vibration on SCraMP);
Photo, video, and sound inputs from user.

These sensors may be used to: generate predictive queries to the digital information system 220, to create relationships (e.g., “A+B+C was significant”) within the digital information system, create new nodes, and/or prompt the user to create nodes, relationship links, or associations.
Step 7: Process inputs to provide outputs: new nodes and associations.
Step 8: Process inputs to provide suggestions for inquiries into the digital information system 220 about the system based on inputs, patterns of inputs, and temporal relationship. Include rates of change of parameters. Present predictive outcomes based on inputs.
Step 9: Process inputs to modify associations between data based on outcomes.

Step 10: Provide Bayesian processor to provide predictive suggestions based on probability of past occurrences (predict next steps based on assessment of prior occurrences (e.g., “what happened here?”). Use Baye's theorem and/or a Bayesian processor and past inputs as an instrument to develop one or more rational responses to a current condition.

### VIII. Additional Considerations

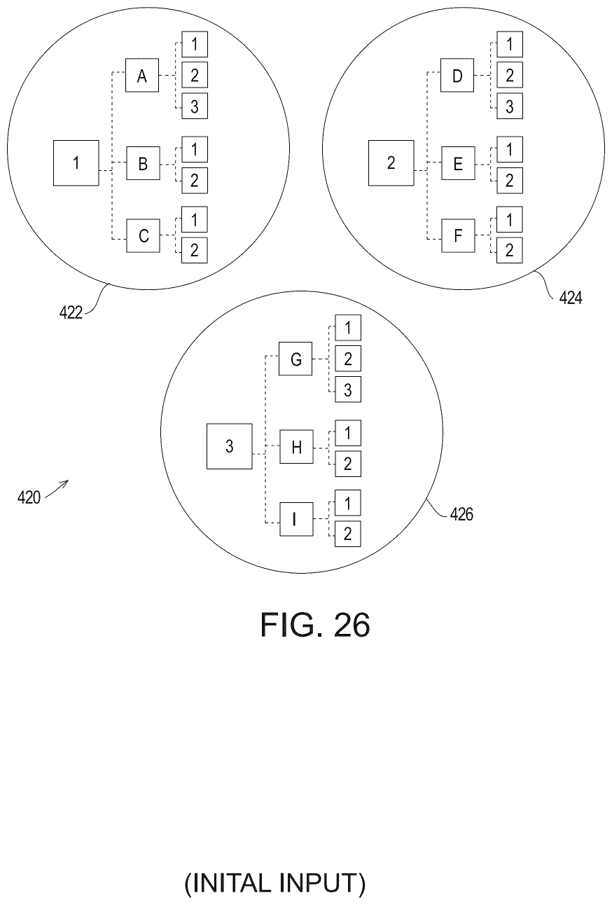

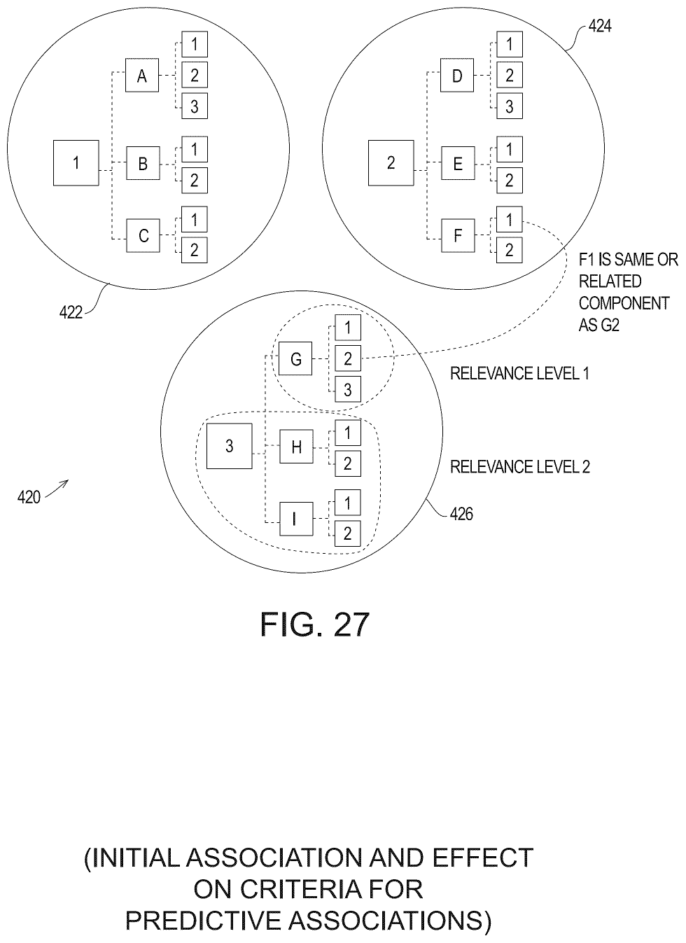

FIG. 26-27 schematically depict an example representation of a digital information system 420 associated a facility such as the facility 20 described above. The example digital information system 420 comprises a plurality of sub-systems each comprising a plurality of components. The number of sub-systems within the facility system and components with each sub-system will vary depending on the nature of the facility associated with the facility system of the present invention, and the example sub-systems and components are to be considered as examples of a more general concept.

In the example depicted in FIGS. 26-28, the example digital information system 420 comprises first, second, and third sub-systems 422, 424, and 426. The example first sub-system 422 comprises components A, B, and C. The example component A comprises sub-components A1, A2, and A3, the example component B comprises sub-components B1 and B2, and the example component C comprises sub-components C1 and C2. The example second sub-system 424 comprises components D, E, and F. The example component D comprises sub-components D1, D2, and D3, the example component E comprises sub-components E1 and E2, and the example component F comprises sub-components F1 and F2. The example third sub-system 426 comprises components G, H, and I. The example component G comprises sub-components G1, G2, and G3, the example component H comprises sub-components H1 and H2, and the example component I comprises sub-components 11 and 12.

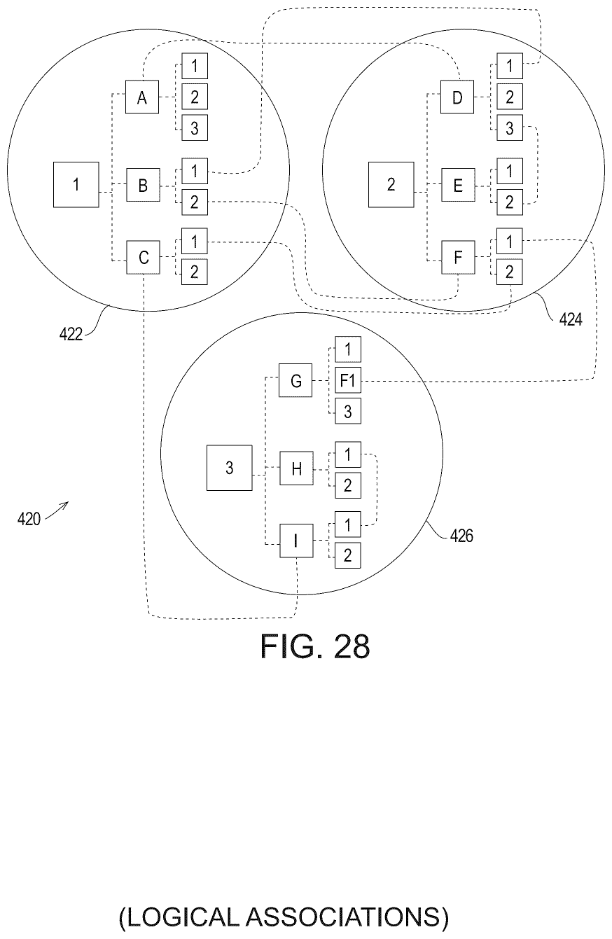

FIG. 26 illustrates an initial input state in which the digital information system 420 is defined upon initiation of the facility associated with the digital information system 420. FIG. 27 illustrates an association established over time between components F1 and G2. FIG. 27 also illustrates first and second relevance levels associated with the third sub-system 426. FIG. 28 illustrates that logical associations between various components can be identified and stored as part of the example digital information system 420.

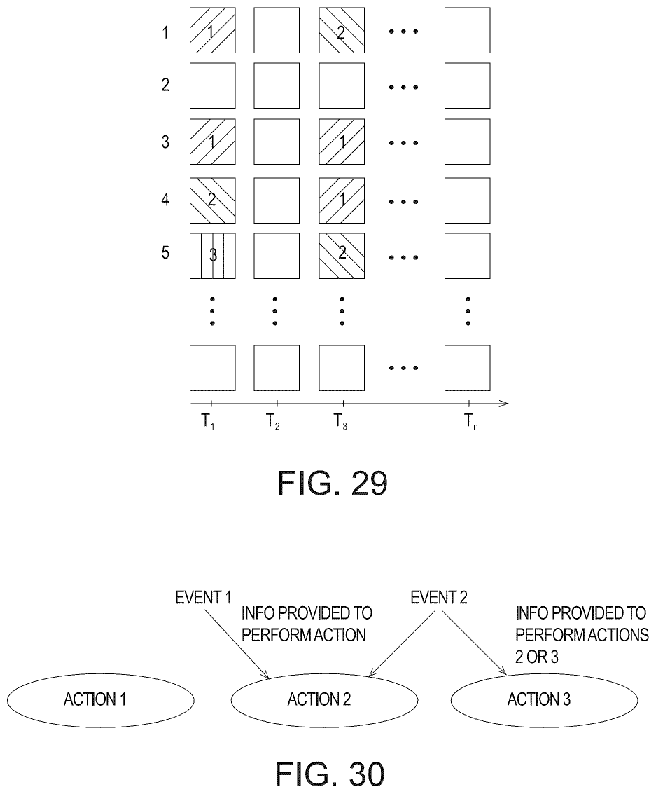

Turning now to FIG. 29 of the drawing, depicted therein is a diagram illustrating the creation of event keys as those event keys are developed over time. In this context, events are defined as a series of inputs which occur individually or simultaneously over time. An event is defined by a signature associated with the event. In particular, FIG. 29 illustrates that the occurrence of inputs that define a pattern that defines or is associated with an event.

In the example depicted in FIG. 29, at a time T1, a first set of event is defined by one or more patterns of inputs/outputs. An Event 1 is associated with inputs/outputs 11 and 13 at a time T1 and inputs/outputs 13 and 14 at a time T3. An Event 2 is associated with inputs/outputs 14 at time T1 and inputs/outputs 11 and 15 at time T3. Event 3, however, is associated with inputs/outputs 15 at time T1 and remains associated with inputs/outputs 15 over time.

As shown in FIG. 30, an event is something that can be associated with an action. In this context, multiple events can trigger a single action, and a single event can trigger multiple actions.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept. The invention illustratively disclosed herein suitably may be practiced in the absence of any element which is not specifically disclosed herein.

What is claimed is:

1. A method of allowing users to maintain equipment forming a facility comprising the steps of:
providing a platform for storing and accessing data;
providing at least one graphical display device for displaying graphical data representative of the facility and the equipment forming the facility;
storing on the platform sensor data generated by sensor associated with the facility and the equipment forming the facility;
allowing users to enter into the platform user data defining parameters associated with the processes and equipment that form an overall system associated with the facility, where the user data includes operations, maintenance, and troubleshooting data associated with individual pieces of equipment forming the facility, assets associated with the facility, and
subsystems containing multiple pieces of equipment that work together within the overall system;
controlling the platform to combine the sensor data with the user data based on context, chronology, and spatial relationships to generate state data communicating whether the overall system associated with the facility, the individual pieces of equipment forming the facility, and the subsystems forming the facility are operating within predefined parameters; and
controlling the at least one graphical display device to display the state data to users.

2. The method of claim 1, further comprising the steps of:
controlling the platform to generate predictive data predicting, based on the sensor data and the user data, whether future operation of the overall system associated with the facility, the individual pieces of equipment forming the facility, and the subsystems forming the facility are likely to operate within predefined parameters; and
controlling the at least one graphical display device to display the predictive data to users.

3. The method of claim 1, further comprising the step of controlling the at least one graphical display device to display to users both the state data and location data associated with users' locations within the facility.

4. The method of claim 1, further comprising the step of controlling the at least one graphical display device to allow users to enter user data such that the graphical display device further causes location data associated with the facility, the individual pieces of equipment forming the facility, and the subsystems forming the facility to be associated with user data when stored on the platform.

5. The method of claim 1, further comprising the steps of:
storing on the platform equipment data associated with individual pieces of equipment forming the facility; and
controlling the at least one graphical display device to display to users both the state data and the equipment data.

6. The method of claim 1, further comprising the steps of:
storing on the platform asset data associated with individual pieces of equipment forming the facility; and
controlling the at least one graphical display device to display to users both the state data and the equipment data.

7. The method of claim 1, further comprising the steps of:
storing on the platform equipment data associated with individual pieces of equipment forming the facility;
storing on the platform asset data associated with individual pieces of equipment forming the facility; and
controlling the at least one graphical display device to display to users the state data, the equipment data, and the asset data.

8. The method of claim 1, further comprising the steps of:
generating maintenance data based on the state data; and
displaying the maintenance data to the users.

9. A method of allowing users to maintain equipment forming a facility comprising the steps of:
providing a platform for storing and accessing data;
providing at least one graphical display device for displaying graphical data representative of the facility and the equipment forming the facility;
storing on the platform sensor data generated by sensor associated with the facility and the equipment forming the facility;
allowing users to enter into the platform user data defining parameters associated with the processes and equipment that form an overall system associated with the facility, where the user data includes operations, maintenance, and troubleshooting data associated with individual pieces of equipment forming the facility, assets associated with the facility, and
subsystems containing multiple pieces of equipment that work together within the overall system;
controlling the platform to generate predictive data predicting, based on the sensor data and the user data, whether future operation of the overall system associated with the facility, the individual pieces of equipment forming the facility, and the subsystems forming the facility are likely to operate within predefined parameters; and
controlling the at least one graphical display device to display the predictive data to users.

10. The method of claim 9, further comprising the step of controlling the at least one graphical display device to display to users both the predictive data and location data associated with users' locations within the facility.

11. The method of claim 9, further comprising the step of controlling the at least one graphical display device to allow users to enter user data such that the graphical display device further causes location data associated with the facility, the individual pieces of equipment forming the facility, and the subsystems forming the facility to be associated with user data when stored on the platform.

12. The method of claim 9, further comprising the steps of:
storing on the platform equipment data associated with individual pieces of equipment forming the facility; and
controlling the at least one graphical display device to display to users both the predictive data and the equipment data.

13. The method of claim 9, further comprising the steps of:
storing on the platform asset data associated with individual pieces of equipment forming the facility; and
controlling the at least one graphical display device to display to users both the predictive data and the equipment data.

14. The method of claim 9, further comprising the steps of:
storing on the platform equipment data associated with individual pieces of equipment forming the facility;
storing on the platform asset data associated with individual pieces of equipment forming the facility; and
controlling the at least one graphical display device to display to users the predictive data, the equipment data, and the asset data.

15. The method of claim 9, further comprising the steps of:
generating maintenance data based on the predictive data; and
displaying the maintenance data to the users.
